(19) United States
(12) Patent Application Publication
(10) Pub. No.: US 2008/0280076 A1
(43) Pub. Date: Nov. 13, 2008

(54) Decorative safety glass

(76) Inventors: Richard Allen Hayes, Beaumont, TX (US); Rebecca L. Smith, Vienna, WV (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/801,795

(22) Filed: May 11, 2007

(51) Int. Cl. B44F 1/04

(52) U.S. Cl. 428/29; 156/277

(57) ABSTRACT

An image-bearing article comprising an interlayer bearing an image wherein the interlayer is an acoustic poly(vinyl acetal) interlayer having a Tg 23° C. or less. The acoustic poly(vinyl acetal) interlayer is preferably laminated to a film layer, a white layer, a second interlayer sheet or a rigid layer. The image-bearing article can preferably be coated on the image-bearing side and over the image with an adhesion promoter.

### FIELD OF THE INVENTION

The present invention relates to image-bearing safety glass articles.

### BACKGROUND OF THE INVENTION

Glass laminated products have contributed to society for almost a century. Beyond the well known, every day automotive safety glass used in windshields, laminated glass is used in all forms of the transportation industry. It is utilized as windows for trains, airplanes, ships, and nearly every other mode of transportation. Safety glass is characterized by high impact and penetration resistance and does not scatter glass shards and debris when shattered.

Safety glass typically consists of a sandwich of two glass sheets or panels bonded together with an interlayer of a polymeric film or sheet, which is placed between the two glass sheets. One or both of the glass sheets may be replaced with optically clear rigid polymeric sheets, such as sheets of polycarbonate materials. Safety glass has further evolved to include multiple layers of glass and polymeric sheets bonded together with interlayers of polymeric films or sheets.

The interlayer is typically made with a relatively thick polymer film or sheet, which exhibits toughness and bondability to provide adhesion to the glass in the event of a crack or crash. Over the years, a wide variety of polymeric interlayers have been developed to produce laminated products. In general, these polymeric interlayers must possess a combination of characteristics including very high optical clarity, low haze, high impact resistance, high penetration resistance, excellent ultraviolet light resistance, good long term thermal stability, excellent adhesion to glass and other rigid polymeric sheets, low ultraviolet light transmittance, low moisture absorption, high moisture resistance, excellent long term weatherability, among other requirements. Widely used interlayer materials utilized currently include complex, multicomponent compositions based on poly(vinyl acetal) (preferably poly(vinyl butyral) (PVB)).

Glass laminates having properties tailored for specific end-uses have been developed. For instance, glass laminates that provide acoustic benefits, including those that describe poly(vinyl acetal) interlayers having improved acoustical performance, include U.S. Pat. No. 4,614,676, 4,742,107, 5,190,826, 5,340,654, 5,368,917, 5,464,659, 5,478,615, 5,773,102, 6,074,732, 6,119,807, 6,132,882, 6,432,522, 6,821,629, 6,825,255, 6,887,577, 6,903,152, 2002/006504, 2006/0008648, 2006/0210776, 2006/0210782, 2006/63007, 2006/70694, and 2007/0009714.

Recent patent applications describe image-bearing (e.g., decorated) glass laminates prepared by various means, including laminates containing an image (e.g., a decoration) digitally printed on poly(vinyl butyral) interlayer sheets using ink-jet technology. They include: US 2004/0234735, 2005/0234185, 2005/0285920, 2005/0271865, 2005/0048229, 2005/0118401, 2005/0196560 and 2006/0099356, and U.S. Ser. No. 11/645974, filed Dec. 27, 2006, Ser. No. 11/647735, filed Dec. 29, 2006, and Ser. No. 11/648418, filed Dec. 29, 2006.

The described image-bearing laminates have a number of drawbacks, including (in some cases) poor adhesion between the image-bearing area and glass (which significantly reduces the attributes for safety glass applications), reduced image sharpness due to plasticizers, lack of acoustic barrier and solar control attributes, and undesirably complicated processes to produce the image-bearing article and the glass laminate therefrom. The invention overcomes these shortcomings and provides image-bearing (e.g., decorated) safety glass laminates with high interlayer adhesion, image stability, acoustic barrier and preferably solar control attributes which maintain the safety aspects generally assumed for laminated safety glass. The invention overcomes these shortcomings and provides image-bearing (e.g., decorated) safety glass laminates with high interlayer adhesion, image stability, acoustic barrier and preferably solar control attributes, which maintain the safety aspects generally assumed for laminated safety glass.

### SUMMARY OF THE INVENTION

The invention is directed to an image-bearing article comprising an interlayer bearing an image wherein the interlayer is an acoustic poly(vinyl acetal) interlayer having a Tg of 23° C. or less. Preferably the Tg is 0 to about 23° C., more preferably about 20 to about 23° C.

In a first preferred embodiment, the acoustic poly(vinyl acetal) interlayer is an interlayer of poly(vinyl acetal) with acetal groups derived from reacting poly(vinyl alcohol) with aldehydes containing 6 to 10 carbon atoms. (The resultant product contains groups containing 10-14 carbon atoms as two adjacent alcohols will react with an aldehyde to form an acetyl ring with an alkyl chain.) Preferably the aldehydes are selected from the group consisting of n-hexylaldehyde, 2-ethylbutyraldehyde, n-heptylaldehyde, n-octylaldehyde, n-nonylaldehyde, n-decylaldehyde, benzaldehyde, and cinnamaldehyde. Preferably the poly(vinyl acetal) is produced by acetalizing poly(vinyl alcohol) with aldehydes containing 6 to 10 carbon atoms to a degree of acetalization of at least 50 mole % and has an average polymerization degree of from about 1000 to about 3000, and even more preferably by acetalizing poly(vinyl alcohol) with at least 95 mole % saponification degree. Preferably the aldehydes contain 6 to 8 carbon atoms. Preferably the poly(vinyl acetal) contains plasticizer in an amount of about 30 to about 60 parts per hundred (pph) based on 100 parts by weight of poly(vinyl acetal). Preferably the poly(vinyl alcohol) contains residual acetyl groups in the range of about 2 to about 0.01 mole % of the total of the main chain vinyl groups.

In a second preferred embodiment, the acoustic poly(vinyl acetal) interlayer is an interlayer of poly(vinyl acetal) with acetyl groups in the range of about 8 to about 30 mole % of the total of the main chain vinyl groups. Preferably the acoustic poly(vinyl acetal) interlayer is an interlayer of poly(vinyl acetal) with acetal groups derived from reacting poly(vinyl alcohol) with aldehydes containing 4 to 6 carbon atoms. Preferably the aldehydes are selected from the group consisting of n-butyl aldehyde, isobutyl aldehyde, valeraldehyde, n-hexyl aldehyde and 2-ethylbutyl aldehyde and mixtures thereof. Preferably the poly(vinyl acetal) has an average polymerization degree of from about 500 to about 3000. Preferably the poly(vinyl acetal) has a degree of acetalization for the polyvinyl acetal resin is 40 mole % or greater, and more preferably 50 mole % or greater. Preferably the poly(vinyl acetal) contains plasticizer in an amount of about 30 to about 70 parts per hundred (pph) based on 100 parts by weight of poly(vinyl acetal). Preferably the poly(vinyl acetal) is poly(vinyl butyral).

In a third preferred embodiment, the acoustic poly(vinyl acetal) interlayer is an interlayer of poly(vinyl acetal) containing plasticizer in an amount of about 40 to about 60 parts per hundred (pph) (preferably about 40 to about 50 pph) based on 100 parts by weight of poly(vinyl acetal). Preferably the poly(vinyl acetal) is produced by acetalizing poly(vinyl alcohol) with at least 95 mole % saponification degree. Preferably the acoustic poly(vinyl acetal) interlayer is an interlayer of poly(vinyl acetal) containing plasticizer in an amount of about 40 to about 60 parts per hundred (pph) based on 100 parts by weight of poly(vinyl acetal). Preferably the poly(vinyl acetal) is poly(vinyl butyral).

In a preferred embodiment, the image-bearing surface of the interlayer contains a coating of an adhesion promoter.

Preferably the image-bearing article comprises a rigid layer adhered to the interlayer, wherein the rigid layer is selected from the group consisting of glass, poly(carbonate) and poly(methacrylate) sheets. Preferably the interlayer is adhered on the image-bearing side to the rigid layer by an adhesion promoter.

Preferably the adhesion promoter is selected from the group consisting of silane and poly(alkyl amine) adhesion promoters, and mixtures thereof.

In one preferred embodiment, the adhesion promoter is an aminosilane.

In another preferred embodiment, the adhesion promoter is selected from the group consisting of poly(vinyl amine), poly(allyl amine) and mixtures thereof.

Preferred silane adhesion promoters are selected from the group consisting of vinyltriethoxysilane, vinyltrimethoxysilane, vinyltris(beta-methoxyethoxy)silane, gamma-methacryloxypropyltrimethoxysilane, beta-(3,4-epoxycyclohexyl)ethyltrimethoxysilane, gamma-glycidoxypropyltrimethoxysilane, gamma-glycidoxypropylmethyldiethoxysilane, vinyl-triacetoxysilane, gamma-mercaptopropyltrimethoxysilane, (3-aminopropyl)trimethoxysilane, (3-aminopropyl)triethoxysilane, N-beta-(aminoethyl)-gamma-aminopropyltrimethoxysilane, N-(beta-aminoethyl) gamma-aminopropylmethyldimethoxysilane, aminoethylaminopropyl silane triol homopolymer, vinylbenzylaminoethylaminopropyltrimethoxysilane, bis(trimethoxysilylpropyl)amine, and mixtures thereof.

The more preferred aminosilane adhesion promoters are selected from the group consisting of (3-aminopropyl)trimethoxysilane, (3-aminopropyl)triethoxysilane, N-beta-(aminoethyl)-gamma-aminopropyltrimethoxysilane, N-(beta-aminoethyl) gamma-aminopropylmethyldimethoxysilane, aminoethylaminopropyl silane triol homopolymer, vinylbenzylaminoethylaminopropyltrimethoxysilane, bis(trimethoxysilylpropyl)amine, and mixtures thereof.

The most preferred aminosilane adhesion promoters are selected from the group consisting of gamma-aminopropyltriethoxysilane, and N-beta-(aminoethyl)-gamma-aminopropyl-trimethoxysilane and mixtures thereof.

Preferably the adhesion coating has a thickness of about 1 mil or less.

In one preferred embodiment, the image-bearing article further comprises a film layer laminated to the image-bearing interlayer sheet.

Preferably the film layer is selected from the group consisting of polymeric film and solar control film, more preferably is a solar control film.

In one preferred embodiment, the image-bearing article further comprises a white layer laminated to the image-bearing interlayer sheet.

Preferably the white layer is selected from the group consisting of white film, white sheet, white rigid sheet, frosted glass sheet, and etched glass sheet and most preferably is a white film.

In one preferred embodiment, the image-bearing article further comprises a rigid layer laminated to the image-bearing interlayer sheet.

Preferably the rigid layer is selected from the group consisting of glass, poly(carbonate), and poly(methacrylate) sheets, more preferably is glass sheet.

In a preferred embodiment, the image is applied through an ink jet process.

In a preferred embodiment, the image comprises UV-curable ink.

In a preferred embodiment, the image comprises pigment ink.

In a preferred embodiment, the pigment ink comprises pigment selected from the group consisting of Color Index PY120, PY155, PY128, PY180, PY95, PY93, PV19/PR202, PB15:3, PB15:4, PR122, PB17 and mixtures thereof.

In a preferred embodiment, the ink further comprises a black ink, preferably a carbon black ink.

In a preferred embodiment, the ink further comprises a white ink.

Preferably the image is formed from solvent-based ink.

Preferably the image-bearing article has a laminate adhesive strength of about 1000 psi or greater.

The invention is further directed to a process of forming an image on a poly(vinyl acetal) interlayer sheet, comprising (a) providing a poly(vinyl acetal) interlayer sheet, wherein the interlayer is an acoustic poly(vinyl acetal) interlayer having a Tg of 23° C. or less, and (b) ink-jet printing an image onto the poly(vinyl acetal) interlayer sheet. The interlayer may be laminated with other sheets and films as described herein. Adhesion may be direct or may be assisted by use of an adhesion promoter, etc., as described herein. In one preferred embodiment, the process further comprises laminating the poly(vinyl acetal) interlayer sheet to a rigid layer. Preferably the rigid layer is selected from the group consisting of glass, poly(carbonate) and poly(methacrylate) sheets.

### DETAILED DESCRIPTION OF THE INVENTION

All publications, patent applications, patents, and other references mentioned herein are incorporated by reference in their entirety. Unless otherwise defined, all technical and scientific terms used herein have the same meaning as commonly understood by one of ordinary skill in the art to which this invention belongs. In case of conflict, the present specification, including definitions, will control.

Although methods and materials similar or equivalent to those described herein can be used in the practice or testing of the invention, suitable methods and materials are described herein.

Unless stated otherwise, all % ages, parts, ratios, etc., are by weight.

When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

When the term “about” is used in describing a value or an end-point of a range, the disclosure should be understood to include the specific value or end-point referred to.

As used herein, the terms “comprises,” “comprising,” “includes,” “including,” “containing,” “characterized by,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The transitional phrase “consisting of” excludes any element, step, or ingredient not specified in the claim, closing the claim to the inclusion of materials other than those recited except for impurities ordinarily associated therewith. When the phrase “consists of” appears in a clause of the body of a claim, rather than immediately following the preamble, it limits only the element set forth in that clause; other elements are not excluded from the claim as a whole.

The transitional phrase “consisting essentially of” limits the scope of a claim to the specified materials or steps and those that do not materially affect the basic and novel characteristic(s) of the claimed invention. “A ‘consisting essentially of’ claim occupies a middle ground between closed claims that are written in a ‘consisting of’ format and fully open claims that are drafted in a ‘comprising’ format.”

Where applicants have defined an invention or a portion thereof with an open-ended term such as “comprising,” it should be readily understood that (unless otherwise stated) the description should be interpreted to also describe such an invention using the terms “consisting essentially of” or “consisting of.”

Use of “a” or “an” are employed to describe elements and components of the invention. This is done merely for convenience and to give a general sense of the invention. This description should be read to include one or at least one and the singular also includes the plural unless it is obvious that it is meant otherwise.

In describing certain polymers it should be understood that sometimes applicants are referring to the polymers by the monomers used to make them or the amounts of the monomers used to make them. While such a description may not include the specific nomenclature used to describe the final polymer or may not contain product-by-process terminology, any such reference to monomers and amounts should be interpreted to mean that the polymer is made from those monomers or that amount of the monomers, and the corresponding polymers and compositions thereof.

The materials, methods, and examples herein are illustrative only and, except as specifically stated, are not intended to be limiting.

The invention is based upon the discovery that it is possible to prepare image-bearing articles from certain image-bearing acoustic interlayers and preferably, laminated image-bearing articles from certain image-bearing acoustic interlayers and certain film layers, white layers or rigid layers produced through an ink jet printing process with superior image sharpness, acoustic barrier attributes and interlayer adhesion, and preferably solar control attributes, desirably maintaining the safety aspects commonly associated with safety glass.

In one embodiment, the present invention is an article comprising an image-bearing interlayer, whereby the image is applied through an ink jet printing process and preferably has a coating of an adhesion promoter which is in direct contact with the image.

Polymeric Interlayer Sheet

The polymeric interlayer sheet preferably has a total thickness of about 10 to about 250 mils (0.25-6.35 mm), or more preferably, about 15 to about 90 mils (0.38-2.28 mm), or most preferably, about 30 to about 60 mils (0.76-1.52 mm) to ensure adequate penetration resistance commonly regarded as a feature of safety laminates.

The polymeric interlayer sheets may be formed by any process known in the art, such as extrusion, calandaring, solution casting or injection molding. The parameters for each of these processes can be easily determined by one of ordinary skill in the art depending upon viscosity characteristics of the polymeric material and the desired thickness of the sheet.

The sheet is preferably formed by extrusion.

The polymeric interlayer sheet may have a smooth surface. Preferably, the polymeric sheet to be used as an interlayer within laminates has a roughened surface to effectively allow most of the air to be removed from between the surfaces of the laminate during the lamination process. This can be accomplished, for example, by mechanically embossing the sheet after extrusion or by melt fracture during extrusion of the sheet and the like.

The polymeric interlayer sheet may be combined with other polymeric materials during extrusion and/or finishing to form laminates or multilayer sheets with improved characteristics. A multilayer or laminate sheet may be made by any method known in the art, and may have as many as five or more separate layers joined together by heat, adhesive and/or tie layer, as known in the art. One of ordinary skill in the art will be able to identify appropriate process parameters based on the polymeric composition and process used for sheet formation. Preferable multilayer acoustic poly(vinyl acetal) interlayer sheets are described within, for example, U.S. Pat. No. 6,903,152, US 2006/0210776 and US 2006/0210782.

The interlayer sheet properties may be further adjusted by adding certain additives and fillers to the polymeric composition, such as colorants, dyes, plasticizers, lubricants antiblock agents, slip agents, and the like. The interlayer sheets of the invention may be further modified to provide valuable attributes to the sheets and to the laminates produced therefrom. For example, the sheets may be treated by radiation, for example E-beam treatment of the sheets. E-beam treatment of the and sheets of the invention with an intensity in the range of about 2 MRd to about 20 MRd will provide an increase in the softening point of the sheet (Vicat Softening Point) of about 20° C. to about 50° C. Preferably, the radiation intensity is from about 2.5 MRd to about 15 MRd.

It is understood that the compositions may be used with additives known within the art. The additives may include, for example, plasticizers, processing aides, flow enhancing additives, lubricants, pigments, dyes, flame retardants, impact modifiers, nucleating agents to increase crystallinity, antiblocking agents such as silica, thermal stabilizers, UV absorbers, UV stabilizers, dispersants, surfactants, chelating agents, coupling agents, adhesives, primers and the like. For example, typical colorants may include a bluing agent to reduce yellowing, a colorant may be added to color the laminate or control solar light. The compositions can contain infrared absorbents, such as inorganic infrared absorbents, for example indium tin oxide nanoparticles and antimony tin oxide nanoparticles, and organic infrared absorbents, for example polymethine dyes, amminium dyes, imminium dyes, dithiolene-type dyes and phthalocyanine-type dyes and pigments.

The compositions can contain an effective amount of a thermal stabilizer. Thermal stabilizers are well disclosed within the art. Any known thermal stabilizer will find utility. Preferable general classes of thermal stabilizers include phenolic antioxidants, alkylated monophenols, alkylthiomethylphenols, hydroquinones, alkylated hydroquinones, tocopherols, hydroxylated thiodiphenyl ethers, alkylidenebisphenols, O-, N- and S-benzyl compounds, hydroxybenzylated malonates, aromatic hydroxybenzyl compounds, triazine compounds, aminic antioxidants, aryl amines, diaryl amines, polyaryl amines, acylaminophenols, oxamides, metal deactivators, phosphites, phosphonites, benzylphosphonates, ascorbic acid (vitamin C), compounds which destroy peroxide, hydroxylamines, nitrones, thiosynergists, benzofuranones, indolinones, and the like and mixtures thereof. This should not be considered limiting. Essentially any thermal stabilizer known within the art can be used. The compositions preferably incorporate from 0 to about 1.0 weight % thermal stabilizers, based on the total weight of the composition.

The compositions can contain an effective amount of UV absorber(s). UV absorbers are well disclosed within the art. Any known UV absorber can be used. Preferable general classes of UV absorbers include benzotriazoles, hydroxybenzophenones, hydroxyphenyl triazines, esters of substituted and unsubstituted benzoic acids, and the like and mixtures thereof. This should not be considered limiting. Essentially any UV absorber known within the art can be used. The compositions preferably contain from 0 to about 1.0 weight % UV absorbers, based on the total weight of the composition.

The compositions may contain an effective amount of hindered amine light stabilizers (HALS). Hindered amine light stabilizers (HALS) are generally well disclosed within the art. Generally, hindered amine light stabilizers are disclosed to be secondary, tertiary, acetylated, N-hydrocarbyloxy substituted, hydroxy substituted N-hydrocarbyloxy substituted, or other substituted cyclic amines which further contain steric hindrance, generally derived from aliphatic substitution on the carbon atoms adjacent to the amine function. This should not be considered limiting. Essentially any hindered amine light stabilizer known within the art can be used. The compositions preferably contain from 0 to about 1.0 weight % hindered amine light stabilizers, based on the total weight of the composition.

The image-bearing interlayers are selected from the group consisting of acoustic poly(vinyl acetal) interlayer sheets. Preferably the image-bearing interlayers are selected from the group consisting of acoustic poly(vinyl butyral) interlayers.

Applicants are using the term “acoustic” in reference to certain poly(vinyl acetal) compositions for convenience in describing the invention, although the actual materials are called by other names in many instances and any poly(vinyl acetal) composition or sheet having the general characteristics described herein can be used in practicing the invention.

An image-bearing article comprising an interlayer bearing an image wherein the interlayer is an acoustic poly(vinyl acetal) interlayer having a glass transition temperature (Tg) of 23° C. or less. Preferably the Tg is 0 to about 23° C., more preferably about 20 to about 23° C. As used herein glass transition temperature of poly(vinyl acetal) sheet is determined as described in US 2006/0210776 by rheometric dynamic shear mode analysis using the following procedure. A thermoplastic polymer sheet is molded into a sample disc of 25 millimeters (mm) in diameter. The polymeric sample disc is placed between two 25 mm diameter parallel plate test fixtures of a Rheometrics Dynamic Spectrometer II (available from Rheometrics, Incorporated, Piscataway, N.J.). The polymer sheet sample disc is tested in shear mode at an oscillation frequency of 1 Hertz as the temperature of the sample is increased from −20° C. to 70° C. at a rate of 2° C./minute. The position of the maximum value of tan delta (damping) plotted as dependent on temperature is used to determine glass transition temperature.

In a first preferred embodiment, the acoustic poly(vinyl acetal) interlayer is an interlayer of poly(vinyl acetal) with acetal groups derived from reacting poly(vinyl alcohol) with aldehydes containing 6 to 10 carbon atoms. (The resultant product contains groups containing 10-14 carbon atoms as two adjacent alcohols will react with an aldehyde to form an acetyl ring with an alkyl chain.) Preferably they are produced by acetalizing polyvinyl alcohol with aldehydes containing 6 to 10 carbon atoms to a degree of acetalization of at least 50 mole %. Preferred poly(vinyl alcohol)s are those having an average polymerization degree of from about 1000 to about 3000 and are at least 95 mole % in saponification degree. The aldehydes having 6 to 10 carbon atoms may include aliphatic, aromatic or alicyclic aldehydes. Specific examples of aldehydes having 6 to 10 carbon atoms include n-hexylaldehyde, 2-ethylbutyraldehyde, n-heptylaldehyde, n-octylaldehyde, n-nonylaldehyde, n-decylaldehyde, benzaldehyde, and cinnamaldehyde. The aldehydes may be used alone or in combinations. Preferably, the aldehydes have 6 to 8 carbon atoms. Preferably the poly(vinyl alcohol) contains residual acetyl groups in the range of about 2 to about 0.01 mole % of the total of the main chain vinyl groups.

The poly(vinyl acetal)s may be produced through any known art method. For example, the poly(vinyl acetal)s may be prepared by dissolving the poly(vinyl alcohol) in hot water to obtain an aqueous solution, adding the desired aldehyde and catalyst to the solution which is maintained at the required temperature to cause the acetalization reaction to proceed. The as obtained reaction mixture is then maintained at an elevated temperature to complete the reaction, followed by neutralization, washing with water and drying to obtain the desired product in the form of a resin powder. Preferably, the poly(vinyl acetal) produced has at least a 50 mole % degree of acetalization.

The plasticizer to be admixed with the above produced poly(vinyl acetal) resin may be a monobasic acid ester, a polybasic acid ester or like organic plasticizer, or an organic phosphate or organic phosphite plasticizer. Preferable specific examples of the monobasic esters include glycol esters prepared by the reaction of triethylene glycol with butyric acid, isobutyric acid, caproic acid, 2-ethylbutyric acid, heptanoic acid, n-octylic acid, 2-ethylhexylic acid, pelagonic acid (n-nonylic acid), decylic acid, and the like and mixtures thereof. Additional useful monobasic acid esters may be prepared from tetraethylene glycol or tripropylene glycol with the above mentioned organic acids. Preferable examples of the polybasic acid esters include those prepared from adipic acid, sebacic acid, azelaic acid, and the like and mixtures thereof, with a straight-chain or branched-chain alcohol having 4 to 8 carbon atoms. Preferable examples of the phosphate or phosphite plasticizers include tributoxyethyl phosphate, isodecylphenyl phosphate, triisopropyl phosphite and the like and mixtures thereof. More preferable plasticizers include monobasic esters such as triethylene glycol di-2-ethylbutyrate, triethylene glycol di-2-ethylhexoate, triethylene glycol dicaproate and triethylene glycol di-n-octoate, and dibasic acid esters such as dibutyl sebacate, dioctyl azelate and dibutylcarbitol adipate.

Preferably the plasticizer is used in an amount of from about 30 to about 60 parts by weight per 100 parts by weight of the poly(vinyl acetal). More preferably the plasticizer is used in an amount of from about 30 to about 55 parts by weight per 100 parts by weight of the poly(vinyl acetal). Further additives may be incorporated into the plasticized poly(vinyl acetal) composition, as described above. For example, metal salts of carboxylic acids, including potassium, sodium, or the like alkali metal salts of octylic acid, hexylic acid, butyric acid, acetic acid, formic acid and the like, calcium, magnesium or the like alkaline earth metal salts of the above mentioned acids, zinc and cobalt salts of the above mentioned acids, and stabilizers, such as surfactants such as sodium laurylsulfate and alkylbenzenesulfonic acids may be included. Such acoustic plasticized poly(vinyl acetal) compositions are described within, for example, U.S. Pat. No. 5,190,826.

In a second preferred embodiment, the acoustic poly(vinyl acetal) interlayer is an interlayer of poly(vinyl acetal) with acetyl groups in the range of about 8 to about 30 mole % of the total of the main chain vinyl groups. Preferably the acoustic poly(vinyl acetal) interlayer is an interlayer of poly(vinyl acetal) with acetal groups derived from reacting poly(vinyl alcohol) with aldehydes containing 4 to 6 carbon atoms. These acoustic poly(vinyl acetal) compositions may be prepared from poly(vinyl alcohol) resins which preferably have an average degree of polymerization of from about 500 to about 3000. More preferably, these poly(vinyl acetal) compositions may be prepared from poly(vinyl alcohol) resins which have an average degree of polymerization of from about 1000 to about 2500. The aldehyde to be used to produce the acoustic poly(vinyl acetal)s incorporate from 4 to 6 carbon atoms. Specific examples of aldehydes which incorporate from 4 to 6 carbon atoms include, for example, n-butyl aldehyde, isobutyl aldehyde, valer aldehyde, n-hexyl aldehyde and 2-ethylbutyl aldehyde and mixtures thereof. Preferable aldehydes which incorporate from 4 to 6 carbon atoms include n-butyl aldehyde, isobutyl aldehyde and n-hexyl aldehyde and mixtures thereof. More preferably, the aldehyde which incorporates from 4 to 6 carbon atoms is n-butyl aldehyde and the poly(vinyl acetal) is poly(vinyl butyral). Preferably, the degree of acetalization for the polyvinyl acetal resin is 40 mole % or greater, more preferably, 50 mole % or greater. These poly(vinyl acetal) compositions may be prepared as described above or below. Useful plasticizers for these plasticized poly(vinyl acetal) compositions may be as described above or below. Preferably the plasticizer is used in an amount of from about 30 to about 70 parts by weight per 100 parts by weight of the poly(vinyl acetal), more preferably from about 35 to about 65 parts by weight per 100 parts by weight of the polyvinyl acetal resin. Further additives may be incorporated into the acoustic plasticized poly(vinyl acetal) composition as described above or below. Such acoustic plasticized poly(vinyl acetal) compositions are described within, for example, U.S. Pat. No. 5,340,654 and EP 1 281 690.

In a third preferred embodiment, the acoustic poly(vinyl acetal) interlayer is an interlayer of poly(vinyl acetal) containing plasticizer in an amount of about 40 to about 60 parts per hundred (pph) (preferably about 40 to about 50 pph) based on 100 parts by weight of poly(vinyl acetal). Preferably the poly(vinyl acetal) is produced by acetalizing poly(vinyl alcohol) with at least 95 mole % saponification degree. Preferably the acoustic poly(vinyl acetal) interlayer is an interlayer of poly(vinyl acetal) containing plasticizer in an amount of about 40 to about 60 parts per hundred (pph) based on 100 parts by weight of poly(vinyl acetal). Preferably the poly(vinyl acetal) is poly(vinyl butyral). Such acoustic poly(vinyl butyral) compositions are disclosed within US 2006/008648, US 2006/0210776 and US 2006/0210782.

The acoustic poly(vinyl butyral) will typically have a weight average molecular weight range of from about 30,000 to about 600,000, preferably of from about 45,000 to about 300,000, more preferably from about 200,000 to 300,000, as measured by size exclusion chromatography using low angle laser light scattering. The preferable poly(vinyl butyral) material will incorporate 0 to about 10%, preferably 0 to about 3% residual ester groups, calculated as polyvinyl ester, typically acetate groups, with the balance being butyraldehyde acetal. The poly(vinyl butyral) may incorporate a minor amount of acetal groups other than butyral, for example, 2-ethyl hexanal, as disclosed within U.S. Pat. No. 5,137,954.

The preferable acoustic poly(vinyl butyral) material contains plasticizer. Usable plasticizers are known within the art, for example, as disclosed within U.S. Pat. No. 3,841,890, U.S. Pat. No. 4,144,217, U.S. Pat. No. 4,276,351, U.S. Pat. No. 4,335,036, U.S. Pat. No. 4,902,464, U.S. Pat. No. 5,013,779, and WO 96/28504. The plasticizers may be as described above. Preferable plasticizers include diesters of polyethylene glycol such as triethylene glycol di(2-ethylhexanoate), tetraethylene glycol diheptanoate and triethylene glycol di(2-ethylbutyrate) and dihexyl adipate. Preferably, the plasticizer is one that is compatible (that is, forms a single phase with the poly(vinyl butyral) resin) in the amounts described hereinabove with a poly(vinyl butyral) having a hydroxyl number (OH number) of from about 12 to about 23.

An adhesion control additive, for, for example, controlling the adhesive bond between the glass rigid layer and the polymeric sheet, may also be utilized. These are generally alkali metal or alkaline earth metal salts of organic and inorganic acids. Preferably, they are alkali metal or alkaline earth metal salts of organic carboxylic acids having from 2 to 16 carbon atoms. More preferably, they are magnesium or potassium salts of organic carboxylic acids having from 2 to 16 carbon atoms. The adhesion control additive is typically used in the range of about 0.001 to about 0.5 weight % based on the total weight of the polymeric sheet composition. Other additives, such as antioxidants, ultraviolet absorbers, ultraviolet stabilizers, thermal stabilizers, colorants and the like, such as described above and within U.S. Pat. No. 5,190,826, may also be added to the acoustic poly(vinyl butyral) composition.

Imaging Process

The image (e.g., decoration) may be applied to the interlayer sheet by any known art method. Such methods may include, for example; air-knife, printing, painting, Dahigren, gravure, spraying, thermal transfer print printing, silk screen, thermal transfer, inkjet printing or other art processes. Preferably, the image is applied to the interlayer sheet through digital ink jet printing processes. The image can include, for example, an image, symbol, geometric pattern, photograph, alphanumeric character, and the like and combinations thereof. Such ink jet processes provide the speed and flexibility to meet the needs for producing limited quantities of customized image-bearing layers and laminates at a reasonable cost, which are not available through other, more complex printing processes, such as thermal transfer printing. Inkjet is the dominant print technology in many markets, including desktop publishing and digital photography and is continuing to expand into other areas, such as textile and fabric printing. A major advantage of digital ink jet printing is the minimal setup times required to produce an image which reduces both the cost and turnaround time for a short, customized image production, especially when compared to traditional screen printing operations.

Inkjet printing is typically a wet-imaging, non-contact process where a vehicle or carrier fluid is energized to “jet” ink components from a printhead over a small distance onto a substrate. The vehicle may be solvent based, aqueous based, or a combination thereof and may contain dyes, pigments or a combination thereof. Along with the colorant, an inkjet ink formulation may contain humectants, surfactants, biocides, and penetrants along with other ingredients. Inkjet technologies include continuous and drop-on-demand types, with the drop-on-demand printing the most common. Inkjet printheads generally fall within two broad categories; thermal printheads, mainly used with aqueous inks and piezo-electric printheads, mainly used with solvent inks. Inkjet printer resolutions can now exceed 1440 dpi with photographic and continuous capabilities. Preferably, the image is printed onto the image-bearing layer using a piezo-electric drop-on-demand digital printing process.

A wide array of color options are commercially available for ink jet printing including the standard cyan, magenta, yellow and black (C-M-Y-K) process colors as well as spot color options such as white, metallics, fluorescents, and specialized colors. The term “color” includes all colors including black and white.

The colorants are preferably pigments because of their well-known advantage in fade resistance when exposed to sunlight (color fastness) and their ability to be unaffected by the aggressive plasticizers commonly incorporated within the interlayer sheets (providing enhanced image definition) when compared to dyes. Pigments are further preferred because of their thermal stability, edge definition, and low diffusivity on the printed substrate. In conventional practice, the pigment is suspended in a liquid medium that is conventionally referred to as the “vehicle”. Pigments suitable for use in the practice can be dispersed in an aqueous or a non-aqueous vehicle. The ink can comprise colorant that is dispersed (pigment) in the ink vehicle. The ink vehicle can be aqueous, non-aqueous and the ink is referred to as aqueous or non-aqueous ink, accordingly. Aqueous ink is advantageous because water is especially environmentally friendly.

Preferably, the process uses a solvent based ink system. The term “solvent based ink system” refers to a system in which a colorant is carried in a suitable organic solvent or mixture of solvents, for example, a pigment is dispersed in an organic solvent or mixture of solvents. Such inks include the so called “oil based” inks.

Dispersion of pigment in non-aqueous vehicle is substantially different than dispersion in aqueous vehicle. Generally, pigments that can be dispersed well in water do not disperse well in non-aqueous solvent, and vice versa. Also, the demands of inkjet printing are quite rigorous and the standards of dispersion quality are high. While pigments may be “well dispersed” for other applications, they may still be inadequately dispersed for inkjet applications.

Preferably, the ink set comprises at least three different, non-aqueous, colored pigmented inks (CMY), at least one of which is a magenta ink, at least one of which is a cyan ink, and at least one of which is a yellow ink dispersed in a non-aqueous vehicle. To provide high image definition and resolution within the aggressive plasticizer environment typical of poly(vinyl butyral) interlayers, the pigments are preferably plasticizer resistant. By plasticizer resistant, it is meant that the pigments are little to unaffected in contact with the poly(vinyl butyral) plasticizers, allowing for the avoidance of the art shortcomings of the image fading or losing resolution (image sharpness) throughout the normal product lifetime.

More preferably, the yellow pigment is chosen from the group consisting of Color Index PY120, PY155, PY128, PY180, PY95, PY93 and mixtures thereof. Even more preferably, the yellow pigment is Color Index PY120. A commercial example is PV Fast Yellow H2G (Clariant Corporation, Charlotte, N.C.). This pigment has the advantageous color properties of favorable hue angle, good chroma, and light fastness and further disperses well in non-aqueous vehicle. Even more preferably, the magenta ink comprises a complex of PV19 and PR202 (also referred to as PV19/PR202) dispersed in a non-aqueous vehicle. A commercial example is Cinquasia Magenta RT-255-D (Ciba Specialty Chemicals Corporation, Tarrytown, N.Y.). As noted above, the pigment particles can be an intimate complex of the PV19 and PR202 species and not simply a physical mixture of the individual PV19 and PR202 crystals. This pigment has the advantageous color properties of quinacridone pigments such as PR122 with favorable hue angle, good chroma, and light fastness and further disperses well in non-aqueous vehicle. In contrast, PR122 pigment does not disperse well under similar conditions. Also preferred is a cyan ink comprising PB 15:3 and/or PB 15:4 dispersed in a non-aqueous vehicle. Other preferable pigments include, for example, PR122 and PBI7. The above noted pigment designations are color index numbers.

Preferably, the ink set further comprises a non-aqueous, pigmented black ink, preferably comprising a carbon black pigment dispersed in a non-aqueous vehicle. More preferably, the ink set comprises at least four inks (CMYK). Preferably, the ink set further comprises a non-aqueous, pigmented white ink dispersed in a non-aqueous vehicle. The ink set may comprise a greater number of inks, with 6 inks and 8 inks being common.

This ink set is advantageous because of the desirable combination of plasticizer resistance, chroma, transparency, light fastness and dispersion quality.

The percent coverage of the image is determined by the number of inks utilized within a particular ink set and is defined as it is defined within the art. This includes the option for multistrikes on the same area. Generally this provides for up to 100% coverage on the interlayer sheet for each ink used within a certain ink set. For example, if the ink set includes three inks, then up to 300% coverage is possible. As a further example, if the ink set includes four inks, then up to 400% coverage is possible.

As described above, the preferable colorant in the inks of the ink set is a pigment. By definition, pigments do not form (to a significant degree) a solution in the vehicle and must be dispersed. Traditionally, pigments are stabilized to dispersion by dispersing agents, such as polymeric dispersants or surfactants. More recently, so-called “self-dispersible” or “self-dispersing” pigments (“SDP(s)”) have been developed. As the name would imply, SDPs are dispersible in a vehicle without added dispersants.

Further pigments for inkjet applications are generally well known. A representative selection of such pigments are found, for example, in U.S. Pat. No. 5,026,427, U.S. Pat. No. 5,086,698, U.S. Pat. No. 5,141,556, U.S. Pat. No. 5,169,436 and U.S. Pat. No. 6,160,370, the disclosures of which are incorporated by reference herein for all purposes as if fully set forth. The exact choice of pigment will depend upon color reproduction and print quality requirements of the application.

Dispersants to stabilize the pigments to dispersion are preferably polymeric because of their efficiency. The dispersant can be a random or structured polymeric dispersant. Preferred random polymers include acrylic polymers and styrene-acrylic polymers. More preferable, the dispersant is a structured dispersant such as, for example, AB, BAB and ABC block copolymers, branched polymers and graft polymers. Useful structured polymers are disclosed in, for example, U.S. Pat. No. 5,085,698, EP-A-0556649 and U.S. Pat. No. 5,231,131.

Suitable pigments also include SDPs. SDPs for aqueous inks are well known. SDPs for non-aqueous inks are also known and include, for example, those described in U.S. Pat. No. 5,698,016, US 2001003263, US 2001004871, US 20020056403 and WO 01/94476, the disclosures of which are incorporated by reference herein for all purposes as if fully set forth. The techniques described therein could be applied to the pigments of the invention.

It is desirable to use small pigment particles for maximum color strength and good jetting. The particle size may generally be in the range of from about 0.005 micron to about 15 microns, is typically in the range of from about 0.005 to about 1 micron, is preferably from about 0.005 to about 0.5 micron, and is more preferably in the range of about 0.01 to about 0.3 micron.

The levels of pigment employed in the inks are those levels that are typically needed to impart the desired optical density to the printed image. Typically, pigment levels are in the range of from about 0.01 to about 10 weight %, based on the total weight of the ink.

“Non-aqueous vehicle” refers to a vehicle that is substantially comprised of a non-aqueous solvent or mixtures of such solvent, which solvents can be polar and/or nonpolar. Examples of polar solvents include, for example, alcohols, esters, ketones and ethers, particularly mono- and di-alkyl ethers of glycols and polyglycols such as monomethyl ethers of mono-, di- and tri-propylene glycols and the mono-n-butyl ethers of ethylene, diethylene, and triethylene glycols. Useful, but less preferred, polar solvents include, for example, methyl isobutyl ketone (MIBK), methyl ethyl ketone (MEK), butyrolactone, and cyclohexanone. Examples of nonpolar solvents include, for example, aliphatic and aromatic hydrocarbons having at least six carbon atoms and mixtures thereof including refinery distillation products and byproducts.

Even when no water is deliberately added to the non-aqueous vehicle, some adventitious water may be carried into the formulation, but generally this will be no more than about 2 to about 4 weight %. By definition, the non-aqueous ink will have no more than about 10 weight %, and preferably no more than about 5 weight %, of water based on the total weight of the non-aqueous vehicle.

In a preferred embodiment, dipropylene glycol monomethyl ether acetate (DPMA) is the primary solvent used to disperse the pigmented ink. Mixtures of DPMA with glycol ethers are also preferred.

The amount of the vehicle in the ink is typically in the range of about 70 weight % to about 99.8 weight %, and preferably about 80 weight % to about 99.8 weight %, based on the total weight of the ink.

The inks may optionally contain one or more other ingredients such as, for example, surfactants, binders, bactericides, fungicides, algicides, sequestering agents, buffering agents, corrosion inhibitors, light stabilizers, anti-curl agents, thickeners, and/or other additives and adjuvants well know within the relevant art. These other ingredients may be formulated into the inks and used in accordance with this invention, to the extent that such other ingredients do not interfere with the stability and jetability of the ink, which may be readily determined by routine experimentation. The inks may be adapted by these additives to the requirements of a particular inkjet printer to provide an appropriate balance of properties such as, for example, viscosity and surface tension, and/or may be used to improve various properties or functions of the inks as needed. The amount of each ingredient must be properly determined, but is typically in the range of 0 to about 15 weight % and more typically 0 to about 10 weight %, based on the total weight of the ink.

Surfactants may be used and useful examples include ethoxylated acetylene diols, ethoxylated primary and secondary alcohols, sulfosuccinates, organosilicones and fluoro surfactants. Surfactants, if used, are typically in the amount of about 0.01 to about 5 weight % and preferably about 0.2 to about 2 weight %, based on the total weight of the ink.

Binders may also be used and can be soluble or dispersed polymer(s) added to the ink to improve the adhesion of a pigment. Examples of polymers that can be used include, for example, polyesters, polystyrene/acrylates, sulfonated polyesters, polyurethanes, polyimides, polyvinyl pyrrolidone/vinyl acetate (PVPNA), polyvinyl pyrrolidone (PVP), and the like and mixtures thereof. Other binders are conventionally known and can be used herein. When present, binders are used at levels of at least about 0.3 weight %, preferably at least about 0.6 weight % based on the total weight of the ink. The upper limits are dictated by ink viscosity or other physical limitations.

In a preferred embodiment, the ink is UV curable. UV curable inksets provide the desirability of being less sensitive to interlayer sheet components, such as the acoustic poly(vinyl butyral) plasticizer, providing long term stability of the image. They further reduce or eliminate the need for special treatments or coatings to the image-bearing layer prior to the application of the image to enhance the ink receptiveness. The solvents may also be comprised in part, or entirely, of polymerizable solvents, such as solvents which cure upon application of actinic radiation (actinic radiation curable) or UV light (UV curable). Specific examples of the radically polymerizable monomers and oligomers which may serve a components within such reactive solvent systems include, for example; vinyl monomers (meth)acrylate esters, styrene, vinyltoluene, chlorostyrene, bromostyrene, vinyl acetate, N-vinylpyrrolidone (meth)acrylonitrile, allyl alcohol, maleic acid, maleic anhydride, maleimide, N-methylmaleimide (meth)acrylic acid, itaconic acid, polyethylene glycol mono(meth)acrylate, glycidyl (meth)acrylate, ethylene glycol di(meth)acrylate, trimethylolpropane tri(meth)acrylate, mono(2-(meth)acryloyloxyethyl) acid phosphate, prepolymers having at least one (meth)acryloyl group, polyester (meth)acrylates, polyurethane (meth)acrylates, epoxy(meth)acrylates, polyether (meth)acrylates, oligo(meth)acrylates, alkyd (meth)acrylates, polyol (meth)acrylates, unsaturated polyesters, and the like and mixtures thereof. This should not be taken as limiting. Any radically curable monomer system can be used in the invention.

Preferably, the actinic radiation-curable composition contains a minor amount of a photoinitiator which allows the composition to cure by irradiation with a decreased dose of actinic radiation. In addition, an accelerator (sensitizer), such as an amine-type compound, for example, may also be used. Photo-cationic polymerization initiators, as described below, may also be used. One or more photoinitiators may be added to the composition in a total level of from about 0.1 weight % to about 20 weight % based on the weight of total coating composition.

The image-bearing (decorated) polymeric interlayer sheet is irradiated with actinic radiation (UV light or an electron beam) to cure the image on the polymeric interlayer sheet. The source of actinic radiation may be selected from a low-pressure mercury lamp, high-pressure mercury lamp, metal halide lamp, xenon lamp, excimer laser, and dye laser for UV light, an electron beam accelerator and the like. The dose is usually in the range of 50-3,000 mJ/cm² for UV light and in the range of 0.2-1,000 mu C/cm² for electron beams.

Alternatively, the image may be formed from a photo-cationic-curable material. Generally, photo-cationically-curable materials contain epoxide and/or vinyl ether materials. Upon exposure of a photo-generating acid precursor such as a triarylsulfonium salt, a Lewis acid is generated which is capable of polymerizing the epoxy functional and/or vinyl ether functional materials. The compositions may optionally include reactive diluents and solvents. Examples of preferable optional reactive diluents and solvents include epoxide-containing and vinyl ether-containing materials. In the compositions according to the invention, any type of photoinitiator that, upon exposure to actinic radiation, forms cations that initiate the reactions of the epoxy and/or vinyl ether material(s) can be used. There are a large number of known cationic photoinitiators for epoxy and vinyl ether resins within the art that are suitable. They include, for example, onium salts with anions of weak nucleophilicity, halonium salts, iodosyl salts or sulfonium salts, such as are disclosed in EP 153904 and WO 98/28663, sulfoxonium salts, such as disclosed, for example, in EP 35969, EP 44274, EP 54509, and EP 164314, or diazonium salts, such as disclosed, for example, in U.S. Pat. No. 3,708,296 and U.S. Pat. No. 5,002,856. Other cationic photoinitiators are metallocene salts, such as disclosed, for example, in EP 94914 and EP 94915. A survey of other current onium salt initiators and/or metallocene salts can be found in “UV Curing, Science and Technology” (Editor S. P. Pappas, Technology Marketing Corp., 642 Westover Road, Stamford, Conn., U.S.A.) or “Chemistry & Technology of UV & EB Formulation for Coatings, Inks & Paints”, Vol. 3 (edited by P. K. T. Oldring). One or more photo-cationic initiators may be added to the composition in a total level of from about 0.1 weight % to about 20 weight % based on the weight of total coating composition. The image may be cured as described above.

Jet velocity, drop size and stability are greatly affected by the surface tension and the viscosity of the ink. Ink jet inks typically have a surface tension in the range of about 20 dyne/cm to about 60 dyne/cm at 25° C. Viscosity can be as high as 30 cP at 25° C., but is typically somewhat lower. The inks have physical properties compatible with a wide range of ejecting conditions, i.e., driving frequency of the piezo element, or ejection conditions for a thermal head, for either drop-on-demand device or a continuous device, and the shape and size of the nozzle. The ink set should have excellent storage stability for long periods so as not to clog to a significant extent in an ink jet apparatus. Further, it should not alter the materials of construction of the ink jet printing device it comes in contact with, and will be preferably odorless and non-toxic.

It is preferable that the ink (as an aqueous-based, non-aqueous-based, or a mixture of an aqueous-based and non-aqueous-based vehicles) has a sufficiently low viscosity such that they can be jetted through the printing head of an ink jet printer without the necessity of heating the print head in order to lower the viscosity of the ink. It is, therefore, preferable for the ink viscosity to be below about 30 centipoise (cps), as measured at 25° C., more preferably below about 20 cps at 25° C., even more preferably below about 15 cps at 25° C., and most preferably below about 12 cps at 25° C. Preferably, the ink has a viscosity above about 1 cps at 25° C. to provide good image quality. For drop-on-demand ink jet printers, it is preferable that the ink has a viscosity of above about 1.5 cps at 25° C.

The use of digital image manipulation software, such as Adobe's Photoshop® and/or Illustrator®, in combination with the raster image processing (Postershop® RIP) software can provide a completed printing project from design to finished proof in a matter of hours. For example, Adobe® Photoshop® may be used to produce a postscript file. The postscript file may through suitable interfaces be used to provide the necessary data to the printer for reproduction of the image (decoration). The Postershop® RIP software may additionally be used for scaling and color correction before outputting the necessary data to the printer for reproduction of the image (decoration).

The polymeric interlayer sheet is preferably mechanically stabilized during the printing operation to increase the sheets dimensional stability so as to reduce or avoid color registration or misaligned color placement issues by using a mechanical connection between the interlayer sheet and a removable membrane or substrate. This is preferable for the acoustic poly(vinyl acetal) interlayers of the invention based on their softness, low mechanical strength and low modulus. The removable membrane may take any form. The removable membrane may be a paper backing sheet adhered directly to the interlayer sheet. The removable membrane may further be a suitable sheet material attached to the edges of the interlayer sheet in any suitable manner. The attachment may be, for example, achieved by adhesive tape. Suitable materials for the removable backing may also include, for example, fiber reinforced vinyl. In some processes, the mechanical stabilization can be provided by an attachment to a component of the printing machine. The removable membrane or substrate keeps the polymeric interlayer sheet taut and allows it to be handled without deformation during the process of forming the image. Some of the processes suitable for forming the image require the interlayer to be moved through the system at a consistent rate to prevent “banding and misses” in the printing. In addition, many of the processes suitable for forming the image on the interlayer sheet involve the use of heat. The polymeric interlayer sheets may be very heat sensitive and typically may lose much of their mechanical strength at temperatures of 60° C. and above. The use of a backing membrane or substrate allows the polymeric interlayer sheet to be handled in systems that include the use of heat without stretching or damage.

Any ink jet printer process known may be used to apply the image (decoration) to the interlayer sheet, for example the preferable acoustic poly(vinyl butyral) interlayer of the invention. A specific example of a large format ink jet printer is an MMT paint jet system, (MetroMedia Technologies International, Inc., New York, N.Y.). This printer supports the interlayer such as an acoustic poly(vinyl butyral) interlayer on a large rotating drum, which serves to mechanically stabilize the interlayer. This can be achieved by laying the interlayer on the drum and taping the edges of the interlayer to the rotatable drum using, for example, conventional adhesive tape. This attachment to the rotating drum of the printing machine provides sufficient mechanical stabilization of the interlayer to allow accurate printing on the surface as the drum is rotated adjacent to the print head. The interlayer on the drum is held in close proximity to the printing head, which moves in an axial direction in response to the printer control system. The print head is driven in the conventional manner by the printer electronics. This type of printer typically utilizes a solvent based automotive paint. When UV-curable inksets are utilized, the UV curing lamp is generally attached to the print head(s).

Another ink jet printer design similar to the MMT system described above also utilizes a large drum to support the interlayer. This drum in this system is perforated by a series of apertures and a vacuum is applied to the interior of the drum to hold and mechanically stabilize the interlayer. This system also provides a supply roll which feeds the interlayer to the drum through guide rollers. This system typically utilizes any suitable solvent based pigmented ink.

A Vutek® 5300 digital printing machine (Vutek, Foster City, Calif.) operates by passing the interlayer to be printed over a series of rollers past a print head. The printer holds the interlayer to be printed under tension between rollers to provide a stable surface for printing. The interlayer is preferably stabilized with a sacrificial web which passes through the printer with the interlayer as described above. The sacrificial web can be fiber-reinforced vinyl, paper or any other material which does not stretch under moderate tension. The interlayer can be taped to the sacrificial web. The interlayer and the sacrificial web can be fed to this type of printer through a series of rollers and passes in front of the print head without being stretched or deformed to allow for accurate printing. This type of printer can use a solvent-based pigment.

Flat bed piezo electric drop-on-demand ink jet printers may also be utilized within the invention, especially for interlayers stabilized with the above mentioned sacrificial web. Typically, the printing process is of two general types. In one process, the interlayer is moved across the print head(s) during the printing process, generally through the use of rollers or through movement of the entire flatbed that the interlayer is immobilized in.

In an alternative process, the print head(s) move across the interlayer immobilized in the flat bed. When UV-curable inksets are utilized, the UV curing lamp is generally attached to the print head(s).

Adhesion Promoter Coating

In a further preferable embodiment, the image-bearing surface of the image-bearing interlayer has an adhesive or primer layer, regardless of the process utilized to produce the image-bearing layer. Adhesion at the interface of the image and the other laminate layers is critical in providing the desirable safety laminates. The adhesive layer preferably can take the form of a monolayer of an adhesive primer or of a coating. While the minimum size can be determined based upon the minimal possible size of a monolayer or coating, it can be as small as about 0.0004 mil (about 0.00001 mm) or possibly even smaller. The adhesive/primer coating may be up to about 1 mil (about 0.03 mm), or preferably, up to about 0.5 mil (about 0.013 mm), or more preferably, up to about 0.1 mil (about 0.003 mm), thick. The adhesive may be any adhesive or primer known within the art. The adhesives and primers are used to enhance the bond strength between the image-bearing surface of the image-bearing interlayer and the other laminate layers.

Preferably the adhesion promoter is selected from the group consisting of silane and poly(alkyl amine) adhesion promoters, and mixtures thereof. In one preferred embodiment, the adhesion promoter is an aminosilane. In another preferred embodiment, the adhesion promoter is selected from the group consisting of poly(vinyl amine), poly(allyl amine) and mixtures thereof.

Preferably, the primer or adhesive is selected from vinyltriethoxysilane, vinyltrimethoxysilane, vinyltris(beta-methoxyethoxy)silane, gamma-methacryloxypropyltrimethoxysilane, beta-(3,4-epoxycyclohexyl)ethyltrimethoxysilane, gamma-glycidoxypropyltrimethoxysilane, gamma-glycidoxypropylmethyidiethoxysilane, vinyl-triacetoxysilane, gamma-mercaptopropyltrimethoxysilane, (3-aminopropyl)trimethoxysilane, (3-aminopropyl)triethoxysilane, N-beta-(aminoethyl)-gamma-aminopropyltrimethoxysilane, N-(beta-aminoethyl) gamma-aminopropylmethyldimethoxysilane, aminoethylaminopropyl silane triol homopolymer, vinylbenzylaminoethylaminopropyltrimethoxysilane, bis(trimethoxysilylpropyl)amine, poly(vinyl amine), poly(allyl amine) and the like, and mixtures thereof.

More preferably, the adhesive or primer contains an amine function. Specific examples of such materials include, for example; (3-aminopropyl)trimethoxysilane, (3-aminopropyl)triethoxysilane, N-beta-(aminoethyl)-gamma-aminopropyl-trimethoxysilane, N-(beta-aminoethyl) gamma-aminopropylmethyldimethoxysilane, aminoethylaminopropyl silane triol homopolymer, vinylbenzylaminoethylaminopropyltrimethoxysilane, bis(trimethoxysilylpropyl)amine, poly(vinyl amine), poly(allyl amine) and the like and mixtures thereof. This should not be taken as limiting. Essentially any known primer or adhesive within the art can find utility within the invention.

Commercial examples of such materials include, for Dow Corning Z 6011 Silane (Dow Corning Corporation, Midland, Mich.) and SILQUEST A-1100 silane and A-1102 silane (GE Silicones, Friendly, W. Va.), believed to be (3-aminopropyl)triethoxysilane, Dow Corning Z 6020 Silane (Dow Corning), and SILQUEST A-1120 silane, (GE Silicones) believed to be N-beta-(aminoethyl)-gamma-aminopropyl-trimethoxysilane, SILQUEST A-2120 silane (GE Silicones), believed to be N-(beta-aminoethyl) gamma-aminopropylmethyidimethoxysilane, Dow Corning Z 6137 Silane (Dow Corning), believed to be aminoethylaminopropyl silane triol homopolymer, Dow Corning Z 6040 Silane (Dow Corning), and SILQUESTA-187 silane (GE Silicones), believed to be gamma-glycidoxypropyltrimethoxysilane, Dow Corning Z 6130 Silane (Dow Corning), believed to be methacryloxypropyltrimethoxysilane, Dow Corning Z 6132 Silane (Dow Corning), believed to be vinylbenzylaminoethylaminopropyltrimethoxysilane, Dow Corning Z 6142 Silane (Dow Corning), believed to be gamma-glycidoxypropylmethyldiethoxysilane, Dow Corning Z 6075 Silane (Dow Corning), believed to be vinyltriacetoxysilane, Dow Corning Z 6172 Silane (Dow Corning), and SILQUEST A-172 silane (GE Silicones), believed to be vinyl tris(methoxyethoxy)silane, Dow Corning Z 6300 Silane (Dow Corning), and SILQUESTA-171silane (GE Silicones), believed to be vinyltrimethoxysilane, Dow Corning Z 6518 Silane (Dow Corning), and SILQUEST A-151 silane (GE Silicones), believed to be vinyltriethoxysilane, SILQUESTA-1170 silane (GE Silicones), believed to be bis(trimethoxysilylpropyl)amine and Lupamin® 9095 (BASF Corporation, Florham Park, N.J.) believed to be poly(vinyl amine). These materials have been found to provide adequate adhesion between the image-bearing interlayer surface and the other laminate layers.

Even more preferably, the adhesive or primer is a polyolefin with primary amine functionality, such as poly(vinyl amine), poly(allyl amine) and the like. Such adhesives and primers have been found to provide even higher levels of adhesion between the image-bearing surface of the image-bearing interlayer and the other laminate layers, which is desirable to provide the highest level of safety attributes to the laminates.

The adhesives may be applied through melt processes or through solution, emulsion, dispersion, and the like, coating processes. One of ordinary skill in the art will be able to identify appropriate process parameters based on the composition and process used for the coating formation. The above process conditions and parameters for making coatings by any method in the art are easily determined by a skilled artisan for any given composition and desired application. For example, the adhesive or primer composition can be cast, sprayed, air knifed, brushed, rolled, poured or printed or the like onto the image-bearing interlayer surface. Generally the adhesive or primer is diluted into a liquid medium prior to application to provide uniform coverage over the image-bearing surface. The liquid media may function as a solvent for the adhesive or primer to form solutions or may function as a non-solvent for the adhesive or primer to form dispersions or emulsions. Coatings may also be applied by spraying.

In a further embodiment, image-bearing (e.g., decorated) safety laminates are provided which include at least one image-bearing interlayer and at least one film layer, white layer or rigid layer with a laminate adhesive strength of at least about 1000 psi. In order for the image-bearing safety laminates to function as is commonly assumed for safety laminates, the laminate adhesive strength must be sufficient to avoid delamination. The laminate adhesive strength may be measured by any known test method, for example, through peel testing as described within WO 99/58334. Preferably, the image-bearing safety laminates which include at least one image-bearing interlayer and at least one other laminate layer which have a laminate adhesive strength of at least about 2000 psi, more preferably at least about 3000 psi, and even more preferably at least about 4000 psi.

In another embodiment, the invention contains at least one film layer bound to the image-bearing interlayer by the adhesion promoter. In another embodiment, the invention contains at least one white layer bound to the image-bearing interlayer by the adhesion promoter. In another embodiment, the invention contains at least one rigid layer sheet, such as a glass sheet, bound to the image-bearing interlayer by the adhesion promoter. In another embodiment, the invention contains at least one other interlayer sheet bound to the image-bearing interlayer by the adhesion promoter. The other interlayer sheet is preferably selected from the group consisting of a poly(vinyl acetal) sheets, preferably poly(vinyl butyral) sheets, poly(ethylene-co-vinyl acetate) sheets and ionomer sheets (by “ionomer” reference is to an ionomeric copolymer of an alpha-olefin and about 15 to about 30 wt % of an alpha, beta-ethylenically unsaturated carboxylic acid having 3 to 8 carbons, wherein the alpha olefin comonomer preferably contains 2 to 10 carbon atoms and is preferably ethylene, and the alpha, beta-ethylenically unsaturated carboxylic acid comonomers are preferably acrylic acid, methacrylic acid and mixtures thereof, and which is fully or partially neutralized with a metal or amine salt), whereby the image is applied through an ink jet printing process and has a coating of an adhesion promoter which is in direct contact with the image and the other interlayer sheet. Preferably, the image-bearing surface of the image-bearing interlayer is in contact with another laminate layer, such as the film layer, the white layer, the rigid layer or the other interlayer sheet, to provide a high level of stability to the image from, for example, environmental degradation. By embedding the image, it further protects it from degradation through routine cleaning and the like.

Film Layer

In a preferred embodiment, the invention is directed to an image-bearing article comprising an acoustic interlayer bearing an image and a film layer. The film layer is preferably selected from the group consisting of polymeric film and solar control film. The polymeric film can comprise any polymer known. Specific examples of preferable film materials include; (meth)acrylic compositions, (meth)acrylate ester compositions, polystyrene materials, polyolefin materials, polyethylene compositions, polypropylene compositions, urethane compositions, epoxy compositions, polyester compositions, alkyd resins, polyamide materials, phenoxy compositions, melamine compositions, chlorine-containing materials, fluorine-containing materials, poly(vinyl acetals), polyether compositions, silicone compositions, ABS materials, polysulfone compositions, poly(vinyl chloride) materials, poly(vinylidene chloride) materials, poly(vinyl acetate) materials, poly(vinyl alcohol) materials, poly(phenylene oxide) materials, cellulose derivatives, poly-4-methylpentene, polytetrafluoroethylene, polytrifluoroethylene, polyvinylidene fluoride, ultralow density polyethylene, poly(ethylene-co-vinyl acetate) resins, poly(ethylene-co-glycidylmethacrylate), poly(ethylene-co-(meth)acrylic acid), metal salts of poly(ethylene-co-(meth)acrylic acid), poly(ethylene-co-carbon monoxide), poly(cyclic olefins), poly(ethylene terephthalate), poly(1,3-propyl terephthalate), poly(1,4-butylene terephthalate), poly(ethylene-co-1,4-cyclohexanedimethanol terephthalate), poly(ethylene-co-2,6-naphthalate), syndiotactic polystyrene, polycarbonates, poly(bisphenol A carbonate), starch derivatives, modified starch, cellulose, cellulose derivatives and the like and copolymers thereof and mixtures thereof. This should not be considered limiting. Essentially any polymer may find utility as the polymeric film material of the invention.

Preferably, the polymeric film is transparent. More preferable polymeric film materials include; poly(ethylene terephthalate), poly(1,3-propyl terephthalate), poly(1,4-butylene terephthalate), poly(ethylene-co-1,4-cyclohexanedimethanol terephthalate), polycarbonate, polypropylene, polyethylene, polypropylene, cyclic polyloefins, norbornene polymers, polystyrene, syndiotactic polystyrene, polysulfone, polyamides, poly(urethanes), acrylics, cellulose acetates, cellulose triacetates, cellophane, poly(vinyl chloride) polymers, poly(vinyl fluoride), poly(vinylidene fluoride) and the like. Most preferably, the polymeric film is a biaxially-oriented poly(ethylene terephthalate) film.

Preferably, one or both surfaces of the polymeric film may be treated to enhance the adhesion to the image, to the interlayer, to other laminate layers or a combination thereof. This treatment may take any form known within the art, including adhesives, primers, such as silanes, flame treatments, such as disclosed within U.S. Pat. No. 2,632,921, U.S. Pat. No. 2,648,097, U.S. Pat. No. 2,683,894, and U.S. Pat. No. 2,704,382, plasma treatments, such as disclosed within U.S. Pat. No. 4,732,814, electron beam treatments, oxidation treatments, corona discharge treatments, chemical treatments, chromic acid treatments, hot air treatments, ozone treatments, ultraviolet light treatments, sand blast treatments, solvent treatments, and the like and combinations thereof. For example, a thin layer of carbon may be deposited on one or both surfaces of the polymeric film through vacuum sputtering as disclosed in U.S. Pat. No. 4,865,711. For example, U.S. Pat. No. 5,415,942 discloses a hydroxy-acrylic hydrosol primer coating that may serve as an adhesion-promoting primer for poly(ethylene terephthalate) films.

Preferably, the polymeric film of the invention includes a primer coating on one or both surfaces, more preferably both surfaces, comprising a coating of a polyallylamine-based primer. The polyallylamine-based primer and its application to a poly(ethylene terephthalate) polymeric film are disclosed within U.S. Pat. No. 5,411,845, U.S. Pat. No. 5,770,312, U.S. Pat. No. 5,690,994, and U.S. Pat. No. 5,698,329. Generally, the poly(ethylene terephthalate) film is extruded and cast as a film by conventional methods, as described above, and the polyallylamine coating is applied to the poly(ethylene terephthalate) film either before stretching or between the machine direction stretching and transverse direction stretching operations, and/or after the two stretching operations and heat setting in the stenter oven. It is preferable that the coating be applied before the transverse stretching operation so that the coated poly(ethylene terephthalate) web is heated under restraint to a temperature of about 220° C. in the stenter oven in order to cure the polyallylamine to the poly(ethylene terephthalate) surface(s). In addition to this cured coating, an additional polyallylamine coating can be applied on it after the stretching and stenter oven heat setting in order to obtain a thicker overall coating.

The thickness of the polymeric film is not critical and may be varied depending on the particular application. Generally, the thickness of the polymeric film will range from about 0.1 mils (0.003 mm), to about 10 mils (0.26 mm). For automobile windshields, the polymeric film thickness may be preferably within the range of about 1 mil (0.025 mm), to about 4 mils (0.1 mm).

The polymeric film is preferably sufficiently stress-relieved and shrink-stable under the coating and lamination processes. Preferably, the polymeric film is heat stabilized to provide low shrinkage characteristics when subjected to elevated temperatures (i.e. less than 2 percent shrinkage in both directions after 30 minutes at 150° C.), such are seen through the lamination processes described below.

Preferably, the film layer is a solar control film. The solar control film may reflect infrared light, absorb infrared light or a combination thereof.

Polymeric films coated with indium tin oxide (ITO) nanoparticles incorporated within a matrix material are commercially available. For example, the Tomoegawa Paper Company, Ltd. (Tokyo, Japan) offers a line of solar control films within their Soft Look® film product offering. These solar control films are disclosed as window coverings which are affixed to the outside of a window. The Soft Look® solar control films are described as ITO nanoparticles dispersed within a matrix material and solution coated on biaxially-stretched poly(ethylene terephthalate) film. The Soft Look® solar control films also incorporate a UV shielding hard coat layer on top of the ITO infrared shielding layer and may further incorporate adhesive layers as the outer layers of the films. Typical reported optical properties of the Soft Look® solar control films are, for example; a visible radiation transmittance of 85.80 percent, sunlight radiation transmittance of 68.5 percent, a sunlight reflectance of 7.9 percent, and a screening factor of 0.86. The Soft Look® solar control films are also typically hardcoated to improve the abrasion resistance. Specific grades of Soft Look® solar control films include; Soft Look® UV/IR 25 solar control film and Soft Look® UV/IR 50 solar control film.

Polymeric films coated with antimony tin oxide (ATO) nanoparticles incorporated within a matrix material are also commercially available. For example, the Sumitomo Osaka Cement Company (Tokyo, Japan) offers a line of solar control films within their RAYBARRIER® film product offering. These solar control films are disclosed as window coverings which are affixed to the outside of a window. The RAYBARRIER® solar control films are described as ATO nanoparticles with a nominal particle size of about 10 nm dispersed within a matrix material and coated on biaxially-stretched poly(ethylene terephthalate) film. Typical reported optical properties of the RAYBARRIER® solar control films are, for example; a visible radiation transmittance of 78.9 percent, sunlight radiation transmittance of 66.0 percent, a sunlight reflectance of 8.4 percent, a UV transmittance of 0.4 percent, and a screening factor of 0.8. The RAYBARRIER® solar control films are also typically hardcoated to improve the abrasion resistance, with typical values of a delta H (defined as the haze difference of before and after the Taber abrasion test), of 4.9 percent within a Taber abrasion test (abrasion wheel: CS-10F, Load: 1000 grams and abrasion cycle: 100 cycles), a pass through a steelwool scratching test (steelwool: #0000, load: 200 grams, abrasion times: 200 times back-and-fort, a pass is defined as “not scratched”), and a Pencil Hardness of 2H (Load: 1000 grams). Specific grades of RAYBARRIER® solar control films include; RAYBARRIER® TFK-2583 solar control film with a visible radiation transmittance of 81.6 percent, a sunlight radiation transmittance of 66.8 percent and a haze value of 1.1 percent, RAYBARRIER® TFM-5065 solar control film with a visible radiation transmittance of 67.1 percent, a sunlight radiation transmittance of 47.5 percent and a haze value of 0.4 percent, RAYBARRIER® SFJ-5030 solar control film with a visible radiation transmittance of 29.2 percent, a sunlight radiation transmittance of 43.0 percent and a haze value of 1.0 percent, RAYBARRIER® SFI-5010 solar control film with a visible radiation transmittance of 12.0 percent, a sunlight radiation transmittance of 26.3 percent and a haze value of 0.8 percent, RAYBARRIER® SFH-5040 solar control film with a visible radiation transmittance of 41.5 percent, a sunlight radiation transmittance of 41.9 percent and a haze value of 0.7 percent and RAYBARRIER® SFG-5015 solar control film with a visible radiation transmittance of 14.8 percent, a sunlight radiation transmittance of 20.9 percent and a haze value of 0 percent.

Polymeric films which incorporate lanthanum hexaboride (LaB6) nanoparticles are commercially available. For example, the Sumitomo Metal Mining Company (Tokyo, Japan) offers a line of solar control films which incorporate LaB6 nanoparticles. These solar control films are disclosed as window coverings which are affixed to the outside of a window.

The solar control films can incorporate other absorptive materials, such as, for example, organic infrared absorbents, for example, polymethine dyes, amminium dyes, imminium dyes, dithiolene-type dyes and phthalocyanine-type dyes and pigments, and the like and combinations thereof.

More preferably, the solar control film reflects the infrared light. The preferable metallized polymeric film infrared reflector may include any film with an infrared energy reflective layer. The layer may range from a simple semi-transparent metal layer or be a series of metal/dielectric layers. Such stacks are commonly referred to as interference filters of the Fabry-Perot type. Each layer may be angstrom-thick or thicker. The thickness of the various layers in the filter are controlled to achieve an optimum balance between the desired infrared reflectance while maintaining the also desired visible light transmittance. The metal layer(s) are separated (i.e. vertically in the thickness direction) from each other by one or more dielectric layers so reflection of visible light from the metal layer(s) interferes destructively thereby enhancing visible light transmission. Suitable metals for the metal layer(s) include, for example, silver, palladium, aluminum, chromium, nickel, copper, gold, zinc, tin, brass, stainless steel, titanium nitride, and alloys or claddings thereof. For optical purposes, silver and silver-gold alloys are preferred. Metal layer thickness are generally in the range of from about 60 to about 200 Angstrom, preferably within the range from about 80 to about 140 Angstrom. In general, the dielectric material should be chosen with a refractive index which is greater than the material outside the coating it abuts. In general, a higher refractive index of the dielectric layer(s) is desirable. Preferably, the dielectric material will have a refractive index of greater than about 1.8. More preferably, the dielectric material will have a refractive index of greater than about 2.0. The dielectric layer material should be transparent over the visible range and at least one dielectric layer must exist between a pair of metal layers. Suitable dielectric materials for the dielectric layer(s) include, for example; zirconium oxide, tantalum oxide, tungsten oxide, indium oxide, tin oxide, indium tin oxide, aluminum oxide, zinc sulfide, zinc oxide, magnesium fluoride, niobium oxide, silicon nitride, and titanium oxide. Preferably dielectric materials include tungsten oxide, indium oxide, tin oxide, and indium tin oxide. Generally, the layers are formed through vacuum deposition processes, such as vacuum evaporation processes or sputtering deposition processes. Examples of such processes include resistance heated, laser heated or electron-beam vaporization evaporation processes and DC or RF sputtering processes (diode and magnetron) under normal and reactive conditions. Preferably, the layer is made up of one or more semi transparent metal layers bounded on each side by transparent dielectric layers. One form known as an interference filter comprises at least one layer of reflective metal sandwiched between reflection-suppressing or anti-reflective dielectric layers. These layers are usually arranged in sequence as stacks carried by an appropriate transparent planar substrate such as a biaxially-oriented poly(ethylene terephthalate) film or equivalent film. These layers can be adjusted to reflect particular wave lengths of energy, in particular heat and other infrared wavelengths, as disclosed in, for example; U.S. Pat. No. 4,799,745, U.S. Pat. No. 4,973,511, and the references disclosed above. As is generally known within the art, varying the thickness and composition of a dielectric layer spaced between two reflecting metal layers will vary the optical transmittance/reflection properties considerably. More specifically, varying the thickness of the spacing dielectric layer varies the wave length associated with the reflection suppression (or transmission enhancement) band. In addition to the choice of metal, thickness also determines its reflectivity. Generally, the thinner the layer, the less is its reflectivity. Generally, the thickness of the spacing dielectric layer(s) is between about 200 to about 1200 Angstrom, preferably between about 450 to about 1000 Angstrom, to obtain the desired optical properties. The preferred dielectric stack for the automotive end-uses contains at least two near infrared reflecting metal layers which in operative position transmit at least 70 percent visible light of normal incidence measured as specified in ANSI Z26.1. Architectural applications may utilize dielectric stacks with lower levels of visible light transmittance. Preferably, visible light reflectance, normal from the surface of the stack is less than about 8 percent. Exterior dielectric layers in contact with the metal layer surfaces opposite to the metal surfaces contacting spacing dielectric layer(s) further enhance anti-reflection performance. The thickness of such exterior or outside dielectric layer(s) is generally about 20 to about 600 Angstrom, preferably about 50 to about 500 Angstrom. This should not be considered limiting. Essentially any metallized polymeric film infrared reflector will find utility within the invention.

Commercial examples of such metal dielectric constructs are manufactured by Southwall Technologies, Inc. (Palo Alto, Calif.) in laminated and non-laminated structures with silver and silver/gold as the metal and indium oxide and indium tin oxide as the dielectric. Specific examples of commercially-available metal dielectric constructs from Southwall Technologies, Inc., include, for example, XIR® 70, which is reported to have a 70 percent visible light transmittance, a 9 percent visible light reflectance, (exterior), a 46 percent total solar transmittance, a 22 percent solar reflectance, (exterior), a relative heat gain of 117 and a greater than 99 percent ultraviolet blockage and XIR® 75, which is reported to have a 75 percent visible light transmittance, an 11 percent visible light reflectance, (exterior), a 52 percent total solar transmittance, a 23 percent solar reflectance, (exterior), a relative heat gain of 135 and a greater than 99 percent ultraviolet blockage, when placed in a 2.1 mm clear glass/XIR® film/polyvinyl butyral interlayer/2.1 mm clear glass construction.

White Layer

In a preferred embodiment, the invention is directed to an image-bearing article comprising an acoustic interlayer bearing an image and a white layer.

The white layer may be selected from the group consisting of white film, white sheet, white rigid sheet, frosted glass sheet, and etched glass sheet; and preferably is a white film. The white layer provides high contrast image-bearing safety laminates. The description herein will refer to white layers, but it should be understood that layers of any color can be used in the same way. (The white layer may be any color desired.)

The term “white layer” is meant to include any layer which has a total luminous transmission of less than about 70%, preferably, less than about 50%, more preferably, less than about 30%, yet more preferably, less than about 10%, and even most preferably, less than about 1%, as measured through ASTM test method number D 1003. The white layer is preferably selected from the group consisting of a white film, a white sheet, a white rigid sheet, a frosted glass sheet, an etched glass sheet and combinations thereof, more preferably the white layer is a white film.

White films are articles of commerce and encompass a wide variety of compositions and film types and constructions. The films may be of any composition or construction known. While they are generally white to provide the greatest contrast with the image, this should not be considered limiting and many other colors and shades can be used. These films typically range from being translucent to opaque. Examples include polyolefin films with low spectral transmissions are disclosed within, for example, U.S. Pat. No. 6,020,116, U.S. Pat. No. 6,030,756, U.S. Pat. No. 6,071,654, U.S. Pat. No. 6,200,740, U.S. Pat. No. 6,242,142, and U.S. Pat. No. 6,364,997. White polyester films are disclosed within, for example, U.S. Pat. No. 3,944,699, U.S. Pat. No. 4,780,402, U.S. Pat. No. 4,898,897, U.S. Pat. No. 5,143,765, U.S. Pat. No. 5,223,383, U.S. Pat. No. 5,281,379, U.S. Pat. No. 5,660,931, U.S. Pat. No. 5,672,409, U.S. Pat. No. 5,888,681, U.S. Pat. No. 6,150,012, U.S. Pat. No. 6,187,523, U.S. Pat. No. 6,440,548, U.S. Pat. No. 6,521,351, U.S. Pat. No. 6,641,924, U.S. Pat. No. 6,645,589, U.S. Pat. No. 6,649,250, U.S. Pat. No. 6,783,230, U.S. Pat. No. 6,869,667, U.S. Pat. No. 6,939,600, US 2002/0136880, US 2003/0068466, US 2004/0178139, and EP0 942 031.

Preferably, the white film is thermally dimensionally stable under typical lamination conditions.

The white films may be monolayer or multilayer films formed through, for example, lamination, coextrusion or extrusion coating processes. The layers of a multilayer film may be identical or may be advantageously formed from different compositions. For end-uses which desire highly opaque white films with very low luminous transmission, the so called “white-black-white” films are preferable. The white-black-white films incorporate white outer layers with a core black layer.

The thickness of the white film is not critical and may be varied depending on the particular application. Generally, the thickness of the white film has a thickness of about 10 mils (0.25 millimeters (mm)) or less, preferably about 0.5 mils (0.012 mm) to about 10 mils (0.25 mm), more preferably about 1 mil (0.025 mm) to about 5 mils (0.13 mm).

Preferably, one or both surfaces of the white film may be treated to enhance the adhesion. This treatment may take any form known within the art, including adhesives, primers, such as silanes, flame treatments, such as disclosed within U.S. Pat. No. 2,632,921, U.S. Pat. No. 2,648,097, U.S. Pat. No. 2,683,894, and U.S. Pat. No. 2,704,382, plasma treatments, such as disclosed within U.S. Pat. No. 4,732,814, electron beam treatments, oxidation treatments, corona discharge treatments, chemical treatments, chromic acid treatments, hot air treatments, ozone treatments, ultraviolet light treatments, sand blast treatments, solvent treatments, and the like and combinations thereof. For example, a thin layer of carbon may be deposited on one or both surfaces of the polymeric film through vacuum sputtering as disclosed in U.S. Pat. No. 4,865,711. For example, U.S. Pat. No. 5,415,942 discloses a hydroxy-acrylic hydrosol primer coating that may serve as an adhesion-promoting primer for poly(ethylene terephthalate) films. The polymeric film may include a primer coating on one or both surfaces, more preferably both surfaces, comprising a coating of a polyallylamine-based primer. The polyallylamine-based primer and its application to a poly(ethylene terephthalate) polymeric film are disclosed within U.S. Pat. No. 5,411,845, U.S. Pat. No. 5,770,312, U.S. Pat. No. 5,690,994, and U.S. Pat. No. 5,698,329.

White films are commercially available. For example, the DuPont Teijin Films Company (Wilmington, Del.) offers a wide variety of white films under their Melinex® tradename. Specific examples include Melinex® 226/227 which is described as a milky white polyester film available in 125-350 micron film thicknesses, Melinex® 329 which is described as a white, opaque untreated polyester film available in 55-330 micron film thicknesses, Melinex® 329 Direct Print which is described as a white, opaque polyester film with one side treated available in a 50 micron film thickness, Melinex® 339 which is described as a white, opaque polyester film with both sides treated available in 50-250 micron film thicknesses, Melinex® 377 which is described as a translucent, matte polyester film available in 12-75 micron film thicknesses and Melinex® DTM White which is described as a white film available in 5-, 7-, and 10-mil thicknesses. They further offer Melinex® White-Light Block films in a standard grade 6364 and a grade 6368 with a pretreatment on both surfaces for solvent adhesion. The Melinex® White-Light Block films are totally opaque coextruded white/gray/white layered polyester films. The gray core layer ensures opacity. Further commercial examples include Jindal® 470-JPEL described as a tough milky white polyester available from the Jindal Poly Films Ltd. (New Delhi, India) with a total luminous transmission of 70%. Polymex® P1600 (PSG Group Ltd., London, United Kingdom) is described as a tough milky white polyester film with untreated surfaces with a total luminous transmission of 70% available in 75-350 micron film thicknesses. Polymex® PL822 (PSG Group Ltd.) is described as an opaque white polyester film with chemically-treated surfaces with a total luminous transmission of 70% available in 50-125 micron film thicknesses. The Oce North America, Inc. (Itasca, Ill.) has white film products in which one surface has been treated to be receptive to inkjet coatings, while the other side has been treated with an antistatic agent.

The white layer may be a white sheet which can be formed from any of the materials described for the interlayer sheet or the other interlayer sheet. The white sheet can be described as above for the white film with the exception of thickness. An example of a white sheet is disclosed within US 2005/0142366.

A particularly preferable subset of white sheets contain at least one filler which consists essentially of a composite material obtained from a composition comprising a mineral filler interspersed in a thermoset polymer matrix wherein at least about 80 wt % of the composite filler particles are retained on a number 80 standard sieve. The composite filler material comprises or consists essentially of small particles obtained from solid surface material, such as, for example, Corian® (E. I. du Pont de Nemours and Company, Wilmington, Del. (DuPont)), Wilsonart® (Wilsonart International, Temple, Tex.), Avonite® (Avonite Surfaces™, Florence, Ky.), wherein the solid surface material is a composite of a finely divided mineral filler dispersed in a thermoset organic polymer matrix. The composite filler material can optionally include at least one pigment component. The composite filler as used in the practice imparts a decorative look to the interlayer and to the laminate obtained from the interlayer. Such white sheets are disclosed within, for example, US 2006/110590.

The white layer can also be a frosted or etched glass sheet, which are articles of commerce and well described within the art.

Rigid Layer

In a preferred embodiment, the invention is directed to an image-bearing article comprising an image-bearing acoustic interlayer and a rigid layer. The rigid sheet layer may be selected from the group consisting of glass or rigid transparent plastic sheets, such as, for example, polycarbonate, acrylics, polyacrylate, poly(methyl methacrylate), cyclic polyolefins, such as ethylene norbornene polymers, polystyrene (preferably metallocene-catalyzed) and the like and combinations thereof. Preferably, the rigid sheet layer comprises a material with a modulus of about 100,000 psi (690 MPa) or greater (as measured by ASTM Method D-638). Preferably the rigid sheet layer is selected from the group consisting of glass, polycarbonate, poly(methyl methacrylate), and combinations thereof. More preferably, the rigid sheet layer is a glass sheet.

The term “glass” is meant to include not only window glass, plate glass, silicate glass, sheet glass, low iron glass, and float glass, but also includes colored glass, specialty glass which includes ingredients to control, for example, solar heating, coated glass with, for example, sputtered metals, such as silver or indium tin oxide, for solar control purposes, E-glass, Toroglass, Solex® glass and the like. Such specialty glasses are disclosed in, for example, U.S. Pat. No. 4,615,989, U.S. Pat. No. 5,173,212, U.S. Pat. No. 5,264,286, U.S. Pat. No. 6,150,028, U.S. Pat. No. 6,340,646, U.S. Pat. No. 6,461,736, and U.S. Pat. No. 6,468,934. The glass may also include frosted or etched glass sheet. Frosted and etched glass sheets are articles of commerce and are well disclosed within the common art and literature. The type of glass to be selected for a particular laminate depends on the intended use.

The surfaces of the rigid sheet may be coated or treated to enhance the receptivity of the surface to the image by any suitable method.

Laminates

The laminates may optionally include additional layers, such as other interlayer sheets, white layers, such as white films and sheets to provide high contrast image-bearing laminate articles, other uncoated polymeric films, such as biaxially oriented poly(ethylene terephthalate) film, and other coated polymeric films. The “additional layer” polymeric film and sheets may provide additional attributes, such as acoustical barriers, added penetration resistance and solar control. Preferably, the “additional layers” polymeric film is a biaxially oriented poly(ethylene terephthalate). Preferably the other interlayer sheet is preferably selected from the group consisting of poly(vinyl acetal) sheets, preferably poly(vinyl butyral) sheets, poly(ethylene-co-vinyl acetate) sheets and ionomer sheets. The polymeric films and sheets may additionally have functional coatings applied to them, such as organic infrared absorbers and sputtered metal layers, such as silver, coatings and the like. Adhesives or primers may be included, especially to provide adequate adhesion between the other polymeric layer and the interlayer, as described above.

Preferable representative safety laminate examples include:
glass/image-bearing acoustic poly(vinyl butyral) interlayer (APVB)/solar control film/APVB/glass;
glass/image-bearing APVB/solar control film/poly(vinyl butyral) interlayer (PVB)/glass;
glass/image-bearing APVB/PVB (image in direct contact with PVB)/solar control film/PVB/glass;
glass/image-bearing APVB/solar control film;
glass/image-bearing APVB/APVB (image in direct contact with APVB)/solar control film;
glass/image-bearing APVB/PVB (image in direct contact with PVB)/solar control film;
glass/image-bearing APVB/solar control film/image-bearing APVB/glass;
glass/image-bearing APVB/solar control film/PVB/poly(allyl amine)-primed, biaxially-oriented poly(ethylene terephthalate) film (PET);
   and the like, wherein the image-bearing interlayer sheet preferably comprises an image formed from certain pigments or an UV-curable inkset through an ink jet process, and the image-bearing surface preferably has been primed with poly(allyl amine), poly(vinyl amine), aminosilane or another adhesion promoter.

The laminates can be produced through autoclave and non-autoclave processes, as described below.

The following describes a specific example for the preparation a glass/image-bearing acoustic poly(vinyl butyral) interlayer/solar control film/poly(vinyl butyral)/glass laminate through an autoclave process. The laminate can be formed by conventional autoclave processes known within the art. In a typical process, the glass sheet, the image-bearing acoustic poly(vinyl butyral) interlayer, the solar control film, the poly(vinyl butyral) interlayer and a second glass sheet are laminated together under heat and pressure and a vacuum (for example, in the range of about 27-28 inches Hg (689-711 mm)), to remove air. Preferably, the glass sheet has been washed and dried. A typical glass type is 90 mil thick annealed flat glass. In a typical procedure, the image-bearing acoustic interlayer and the other interlayer are positioned between the solar control film and the glass plates to form a glass/image-bearing acoustic interlayer/solar control film/interlayer/glass assembly, placing the assembly into a bag capable of sustaining a vacuum (“a vacuum bag”), drawing the air out of the bag using a vacuum line or other means of pulling a vacuum on the bag, sealing the bag while maintaining the vacuum, placing the sealed bag in an autoclave at a temperature of about 130° C. to about 180° C., at a pressure of about 150 psi (11.3 bar) to about 250 psi (18.8 bar), for from about 10 to about 50 minutes. Preferably the bag is autoclaved at a temperature of from about 120° C. to about 160° C. for 20 minutes to about 45 minutes. More preferably the bag is autoclaved at a temperature of from about 135° C. to about 160° C. for 20 minutes to about 40 minutes. Most preferably the bag is autoclaved at a temperature of from about 145° C. to about 155° C. for 25 minutes to about 35 minutes. A vacuum ring may be substituted for the vacuum bag. One type of vacuum bags is disclosed within U.S. Pat. No. 3,311,517.

Alternatively, other processes may be used to produce the laminates. Any air trapped within the glass/image-bearing interlayer/white film/interlayer/glass assembly may be removed through a nip roll process. For example, the glass/image-bearing acoustic interlayer/solar control film/interlayer/glass assembly may be heated in an oven at about 80 to about 120° C., preferably about 90 to about 100° C., for about 20 minutes to about 40 minutes. Thereafter, the heated glass/image-bearing acoustic interlayer/solar control film/interlayer/glass assembly is passed through a set of nip rolls so that the air in the void spaces between the glass and the interlayer may be squeezed out, and the edge of the assembly sealed. The assembly at this stage is referred to as a pre-press.

The pre-press assembly may then placed in an air autoclave where the temperature is raised to about 120° C. to about 160° C., preferably about 135° C. to about 160° C., and pressure of about 100 psig to about 300 psig, preferably about 200 psig (14.3 bar). These conditions are maintained for about 15 minutes to about 1 hour, preferably about 20 minutes to about 50 minutes, after which, the air is cooled while no more air is added to the autoclave. After about 20 minutes to about 40 minutes of cooling, the excess air pressure is vented and the laminates are removed from the autoclave. This should not be considered limiting. Essentially any lamination process known within the art may be used with the interlayers.

The laminates can also be produced through non-autoclave processes. Such non-autoclave processes are disclosed, for example, within U.S. Pat. No. 3,234,062, U.S. Pat. No. 3,852,136, U.S. Pat. No. 4,341,576, U.S. Pat. No. 4,385,951, U.S. Pat. No. 4,398,979, U.S. Pat. No. 5,536,347, U.S. Pat. No. 5,853,516, U.S. Pat. No. 6,342,116, U.S. Pat. No. 5,415,909, US 2004/0182493, EP 1 235 683 B1, WO 91/01880 and WO 03/057478 A1. Generally, the non-autoclave processes include heating the pre-press assembly and the application of vacuum, pressure or both. For example, the pre-press may be successively passed through heating ovens and nip rolls.

### EXAMPLES

### Preparative Example PE 1

A plasticized poly(vinyl butyral) composition is prepared by mixing a poly(vinyl butyral) with a hydroxyl number of 18.5 with a plasticizer solution of tetraethylene glycol diheptanoate with 4 grams per liter of Tinuvin® P (Ciba Specialty Chemicals Corporation, Tarrytown, N.Y.), 1.2 grams per liter of Tinuvin® 123 (Ciba), and 8 grams per liter of octylphenol and is extruded so that the residence time in the extruder is within 10 to 25 minutes. The feed ratio of the plasticizer to the dry poly(vinyl butyral) flake is 46:100, (wt.:wt.). An aqueous solution of 3:1 potassium acetate:magnesium acetate is injected during the extrusion to deliver a potassium concentration of 50 to 100 ppm. The melt temperature measured at the slot die is between 190° C. and 215° C. The molten sheet is quenched in a water bath. The self-supporting sheet is passed through a dryer where excess water is allowed to evaporate and then through a relaxer where “quenched in stresses” are substantially relieved. The sheeting is then chilled to less than 10° C., slit along the mid-point of the web width and then wound up into rolls. The die lips at extrusion are adjusted to give the sheeting immediately before slitting a flat cross-sectional thickness profile. After slitting, two rolls of flat acoustic poly(vinyl butyral) sheet are wound up into rolls. The average thickness profile in each roll is 15 mils, (0.38 mm). The roll width is 1.12 meters.

### Preparative Example PE 2

A plasticized poly(vinyl butyral) composition is prepared by mixing a poly(vinyl butyral) with a hydroxyl number of 18.5 with a plasticizer solution of tetraethylene glycol diheptanoate with 4 grams per liter of Tinuvin® P (Ciba Specialty Chemicals Corporation, Tarrytown, N.Y.), 1.2 grams per liter of Tinuvin® 123 (Ciba), and 8 grams per liter of octylphenol and is extruded so that the residence time in the extruder is within 10 to 25 minutes. The feed ratio of the plasticizer to the dry poly(vinyl butyral) flake is 47:100, (wt.:wt.). An aqueous solution of 3:1 potassium acetate:magnesium acetate is injected during the extrusion to deliver a potassium concentration of 50 to 100 ppm. The melt temperature measured at the slot die is between 190° C. and 215° C. The molten sheet is quenched in a water bath. The self-supporting sheet is passed through a dryer where excess water is allowed to evaporate and then through a relaxer where “quenched in stresses” are substantially relieved. The sheeting is then chilled to less than 10° C., slit along the mid-point of the web width and then wound up into rolls. The die lips at extrusion are adjusted to give the sheeting immediately before slitting a flat cross-sectional thickness profile. After slitting, two rolls of flat acoustic poly(vinyl butyral) sheet are wound up into rolls. The average thickness profile in each roll is 30 mils, (0.76 mm). The roll width is 1.12 meters.

### Preparative Example PE 3

A plasticized poly(vinyl butyral) composition is prepared by mixing a poly(vinyl butyral) with a hydroxyl number of 15 with a plasticizer solution of tetraethylene glycol diheptanoate with 4 grams per liter of Tinuvin® P (Ciba Specialty Chemicals Corporation, Tarrytown, N.Y.), 1.2 grams per liter of Tinuvin® 123 (Ciba), and 8 grams per liter of octylphenol and is extruded so that the residence time in the extruder is within 10 to 25 minutes. The feed ratio of the plasticizer to the dry poly(vinyl butyral) flake is 47:100, (wt.:wt.). An aqueous solution of 3:1 potassium acetate:magnesium acetate is injected during the extrusion to deliver a potassium concentration of 50 to 100 ppm. The melt temperature measured at the slot die is between 190° C. and 215° C. The molten sheet is quenched in a water bath. The self-supporting sheet is passed through a dryer where excess water is allowed to evaporate and then through a relaxer where “quenched in stresses” are substantially relieved. The sheeting is then chilled to less than 10° C., slit along the mid-point of the web width and then wound up into rolls. The die lips at extrusion are adjusted to give the sheeting immediately before slitting a flat cross-sectional thickness profile. After slitting, two rolls of flat acoustic poly(vinyl butyral) sheet are wound up into rolls. The average thickness profile in each roll is 40 mils, (1.02 mm). The roll width is 1.12 meters.

### Example 1

An ink set is used which included the following ink formulations; Magenta (36.08 weight % of a magenta pigment dispersion (7 weight % pigment)), 38.35 weight % DOWANOL DPMA (Dow Chemical Company), and 25.57 weight % DOWANOL DPnP (Dow Chemical Company) (based on the total weight of the ink formulation); Yellow (35.23 weight % of a yellow pigment dispersion (7 weight % pigment)), 38.86 weight % DOWANOL DPMA, and 25.91 weight % DOWANOL DPnP (based on the total weight of the ink formulation); Cyan (28.35 weight % of a cyan pigment dispersion (5.5 weight % pigment)), 42.99 weight % DOWANOL DPMA, and 28.66 weight % DOWANOL DPM (Dow Chemical Company), (based on the total weight of the ink formulation); and Black (27.43 weight % of a black pigment dispersion (7 weight % pigment)), 43.54 weight % DOWANOL DPMA, and 29.03 weight % DOWANOL DPM (based on the total weight of the ink formulation). The pigment dispersion compositions and preparations are as disclosed within the Example section of U.S. Pat. No. 7,041,163.

Using the above mentioned ink set, an acoustic sheet prepared in Preparative Example PE 2 is ink jet printed with an image with an Epson 3000 printer to provide an ink coverage of 125 percent.

A solution of SILQUEST A-1100 silane (0.05 weight % based on the total weight of the solution) (GE Silicones) (believed to be gamma-aminopropyltrimethoxysilane), isopropanol (66.63 weight % based on the total weight of the solution), and water (33.32 weight % based on the total weight of the solution) is prepared and allowed to sit for at least one hour prior to use. A 12-inch by 12-inch piece of the image-bearing acoustic sheet is dipped into the silane solution (residence time of about 1 minute) removed and allowed to drain and dry under ambient conditions.

A glass laminate composed of a glass layer, the image-bearing acoustic interlayer and a glass layer is produced in the following manner. The image-bearing acoustic sheet (12 inches by 12 inches (305 mm×305 mm)) is conditioned at 23% relative humidity (RH) at a temperature of 72° F. overnight. The sample is laid up with a clear annealed float glass plate layer (12 inches by 12 inches (305 mm×305 mm) by 2.5 mm thick), the image-bearing acoustic sheet layer and a clear annealed float glass plate layer (12 inches by 12 inches (305 mm×305 mm) by 2.5 mm thick). The glass/interlayer/glass assembly is then placed into a vacuum bag and heated to 90-100° C. for 30 minutes to remove any air contained between the glass/interlayer/glass assembly. The glass/interlayer/glass pre-press assembly is then subjected to autoclaving at 135° C. for 30 minutes in an air autoclave to a pressure of 200 psig, (14.3 bar), as described above. The air is then cooled while no more air is added to the autoclave. After 20 minutes of cooling when the air temperature is less than about 50° C., the excess pressure is vented, and the glass/interlayer/glass laminate is removed from the autoclave.

### Example 2

An acoustic sheet prepared in Preparative Example PE 3 is ink jet printed with an image with a NUR TEMPO Modular Flatbed Inkjet Press (NUR Microprinters, Monnachie, N.J.) equipped with a UV curing lamp on the print heads and utilizing a pigmented 4-color CMYK UV-curable inkset available from NUR Microprinters to provide an ink coverage of 250%.

The image-bearing surface is coated with a 0.5 weight % aqueous solution of poly(vinyl amine) with a #8 casting rod and is dried under ambient conditions.

A glass laminate composed of a glass layer, the primed image-bearing acoustic interlayer and a glass layer is produced in the following manner. The primed image-bearing acoustic sheet (12 inches by 12 inches (305 mm×305 mm)) is conditioned at 23% relative humidity (RH) at a temperature of 72° F. overnight. The sample is laid up with a clear annealed float glass plate layer (12 inches by 12 inches (305 mm×305 mm) by 2.5 mm thick), the primed image-bearing acoustic interlayer and a clear annealed float glass plate layer (12 inches by 12 inches (305 mm×305 mm) by 2.5 mm thick). The glass/interlayer/glass assembly is then laminated as described for Example 1.

### Example 3

Using the above mentioned ink set of Example 1, an acoustic sheet prepared in Preparative Example PE 2 taped to a 6 mils (0.15 mm) thick biaxially-oriented poly(ethylene terephthalate) film is ink jet printed with an image with an Epson 3000 printer to provide an ink coverage of 150%.

The tape and polyester film are removed to provide the image-bearing acoustic sheet.

A solution of Silquest® A-1100 silane, (0.10 weight % based on the total weight of the solution) (GE Silicones) (believed to be gamma-aminopropyltrimethoxysilane), acetic acid (0.01 weight % based on the total weight of the solution), isopropanol (66.59 weight % based on the total weight of the solution), and water (33.30 weight % based on the total weight of the solution) is prepared. A 12-inch by 12-inch piece of the image-bearing acoustic sheet is dipped into the silane solution (residence time of about 1 minute), removed and allowed to drain and dry under ambient conditions.

A glass laminate composed of a glass layer, the silane-primed image-bearing acoustic interlayer and a glass layer is produced in the following manner. The primed image-bearing acoustic sheet (12 inches by 12 inches (305 mm×305 mm)) is conditioned at 23% relative humidity (RH) at a temperature of 72° F. overnight. The sample is laid up with a clear annealed float glass plate layer (12 inches by 12 inches (305 mm×305 mm) by 2.5 mm thick), the primed image-bearing acoustic interlayer and a clear annealed float glass plate layer (12 inches by 12 inches (305 mm×305 mm) by 2.5 mm thick). The glass/interlayer/glass assembly is then laminated as described for Example 1.

### Example 4

An acoustic sheet prepared above in Preparative Example PE 3 taped to a 6 mils (0.15 mm) thick biaxially-oriented poly(ethylene terephthalate) film is ink jet printed on the with an image with a NUR TEMPO Modular Flatbed Inkjet Press (NUR Microprinters, Monnachie, N.J.) equipped with a UV curing lamp on the print heads and utilizing a pigmented 6-color CMYK+Iclm UV-curable inkset and a UV-curable white ink available from NUR Microprinters to provide an ink coverage of 450%. The tape and polyester film are removed to provide the image-bearing acoustic sheet.

A solution of SILQUEST A-1100 silane (0.025 weight % based on the total weight of the solution) (GE Silicones) (believed to be gamma-aminopropyltrimethoxysilane), isopropanol (66.65 weight % based on the total weight of the solution), and water (33.32 weight % based on the total weight of the solution) is prepared and allowed to sit for at least one hour prior to use. A 12-inch by 12-inch piece of the image-bearing acoustic sheet is dipped into the silane solution (residence time of about 1 minute), removed and allowed to drain and dry under ambient conditions.

A glass laminate composed of a glass layer, the silane-primed image-bearing acoustic interlayer and a glass layer is produced in the following manner. The silane-primed image-bearing acoustic sheet (12 inches by 12 inches (305 mm×305 mm)) is conditioned at 23% relative humidity (RH) at a temperature of 72° F. overnight. The sample is laid up with a clear annealed float glass plate layer (12 inches by 12 inches (305 mm×305 mm) by 2.5 mm thick), the primed image-bearing acoustic sheet layer and a clear annealed float glass plate layer (12 inches by 12 inches (305 mm×305 mm) by 2.5 mm thick). The glass/interlayer/glass assembly is then laminated as described for Example 1.

### Example 5

Using the above mentioned ink set of Example 1, an acoustic sheet prepared in Preparative Example PE 1 taped to a 6 mils (0.15 mm) thick biaxially-oriented poly(ethylene terephthalate) film is ink jet printed with an image with an Epson 3000 printer to provide an ink coverage of 250%. The tape and polyester film are removed to provide the image-bearing acoustic sheet.

The image-bearing surface is coated with a 0.5 weight % aqueous solution of poly(vinyl amine) with a #8 casting rod and is dried under ambient conditions.

A glass laminate composed of a glass layer, the primed image-bearing acoustic interlayer, an acoustic sheet prepared in Preparative Example PE 1 and a glass layer is produced in the following manner. The primed image-bearing sheet (12 inches by 12 inches (305 mm×305 mm)) and the acoustic sheet from Preparative Example PE 1 (12 inches by 12 inches (305 mm×305 mm) by 15 mils thick (0.38 mm)) are conditioned at 23% relative humidity (RH) at a temperature of 72° F. overnight. The sample is laid up with a clear annealed float glass plate layer (12 inches by 12 inches (305 mm×305 mm) by 2.5 mm thick), the primed image-bearing acoustic interlayer, the acoustic interlayer (with the image-bearing surface of the image-bearing acoustic interlayer in contact with the surface of the acoustic interlayer) and a clear annealed float glass plate layer (12 inches by 12 inches (305 mm×305 mm) by 2.5 mm thick). The glass/interlayer/glass assembly is then laminated as described in Example 1.

### Example 6

An acoustic sheet prepared in Preparative Example PE 1 taped to a 6 mils (0.15 mm) thick biaxially-oriented poly(ethylene terephthalate) film is ink jet printed with an image with a NUR TEMPO Modular Flatbed Inkjet Press (NUR Microprinters, Monnachie, N.J.) equipped with a UV curing lamp on the print heads and utilizing a pigmented 4-color CMYK UV-curable inkset available from NUR Microprinters to provide an ink coverage of 350%. The tape and polyester film are removed to provide the image-bearing acoustic sheet.

A solution of Silquest® A-1100 silane, (0.10 weight % based on the total weight of the solution) (GE Silicones) (believed to be gamma-aminopropyltrimethoxysilane), acetic acid (0.01 weight % based on the total weight of the solution), isopropanol (66.59 weight % based on the total weight of the solution), and water (33.30 weight % based on the total weight of the solution) is prepared. A 12-inch by 12-inch piece of the image-bearing acoustic sheet is dipped into the silane solution (residence time of about 1 minute), removed and allowed to drain and dry under ambient conditions.

A glass laminate composed of a glass layer, the silane-primed image-bearing acoustic interlayer, a white film layer, an acoustic sheet prepared above in Preparative Example PE 2 and a glass layer is produced in the following manner. The primed image-bearing acoustic sheet (12 inches by 12 inches (305 mm×305 mm)), the Melinex® 329 white film (12 inches by 12 inches (305 mm×305 mm) by 5 mils thick (0.13 mm) (DuPont Teijin Films Company, Wilmington, Del.), and the acoustic sheet (12 inches by 12 inches (305 mm×305 mm) by 30 mils thick (0.76 mm)) are conditioned at 23% relative humidity (RH) at a temperature of 72° F. overnight. The sample is laid up with a clear annealed float glass plate layer (12 inches by 12 inches (305 mm×305 mm) by 2.5 mm thick), the primed image-bearing acoustic interlayer, the white film layer, the acoustic interlayer and a clear annealed float glass plate layer (12 inches by 12 inches (305 mm×305 mm) by 2.5 mm thick). The glass/interlayer/glass assembly is then laminated as described for Example 1.

### Example 7

An acoustic sheet prepared above in Preparative Example PE 3 taped to a 6 mils (0.15 mm) thick biaxially-oriented poly(ethylene terephthalate) film is ink jet printed on the with an image with a NUR TEMPO Modular Flatbed Inkjet Press (NUR Microprinters, Monnachie, N.J.) equipped with a UV curing lamp on the print heads and utilizing a pigmented 6-color CMYK+Iclm UV-curable inkset and a UV-curable white ink available from NUR Microprinters to provide an ink coverage of 500%. The tape and polyester film are removed to provide the image-bearing acoustic sheet.

A solution of SILQUEST A-1100 silane (0.025 weight % based on the total weight of the solution) (GE Silicones) (believed to be gamma-aminopropyltrimethoxysilane), isopropanol (66.65 weight % based on the total weight of the solution), and water (33.32 weight % based on the total weight of the solution) is prepared and allowed to sit for at least one hour prior to use. A 12-inch by 12-inch piece of the image-bearing acoustic sheet is dipped into the silane solution (residence time of about 1 minute), removed and allowed to drain and dry under ambient conditions.

A glass laminate composed of a glass layer, the silane-primed image-bearing acoustic interlayer, a white film layer, a Butacite® poly(vinyl butyral) sheet (DuPont) and a glass layer is produced in the following manner. The silane-primed image-bearing acoustic sheet (12 inches by 12 inches (305 mm×305 mm)), a Melinex® White-Light Block film grade 6364 (12 inches by 12 inches (305 mm×305 mm)) (DuPont Teijin Films Company) and the Butacite® poly(vinyl butyral) sheet (12 inches by 12 inches (305 mm×305 mm) by 15 mils thick (0.38 mm)) are conditioned at 23% relative humidity (RH) at a temperature of 72° F. overnight. The sample is laid up with a clear annealed float glass plate layer (12 inches by 12 inches (305 mm×305 mm) by 2.5 mm thick), the primed image-bearing acoustic interlayer, the white film layer, the Butacite® sheet interlayer and a clear annealed float glass plate layer (12 inches by 12 inches (305 mm×305 mm) by 2.5 mm thick). The glass/interlayer/glass assembly is then laminated as described for Example 1.

### Example 8

Using the above mentioned ink set of Example 1, an acoustic sheet prepared in Preparative Example PE 2 taped to a 6 mils (0.15 mm) thick biaxially-oriented poly(ethylene terephthalate) film is ink jet printed with an image with an Epson 3000 printer to provide an ink coverage of 250%. The tape and polyester film are removed to provide the image-bearing acoustic sheet.

The image-bearing surface is coated with a 0.5 weight % aqueous solution of poly(vinyl amine) with a #8 casting rod and is dried under ambient conditions.

A glass laminate composed of a glass layer, the silane-primed image-bearing acoustic interlayer, a white film layer, a Butacite® poly(vinyl butyral) sheet layer (DuPont) and a glass layer is produced in the following manner. The primed image-bearing acoustic sheet (12 inches by 12 inches (305 mm×305 mm)) and the Butacite® poly(vinyl butyral) sheet (12 inches by 12 inches (305 mm×305 mm) by 15 mils thick (0.38 mm)) are conditioned at 23% relative humidity (RH) at a temperature of 72° F. overnight. The sample is laid up with a clear annealed float glass plate layer (12 inches by 12 inches (305 mm×305 mm) by 2.5 mm thick), the primed image-bearing acoustic interlayer, the Melinexe 226/227 white film (12 inches by 12 inches (305 mm×305 mm) by 6 mils thick (0.15 mm) (DuPont Teijin Films Company), the Butacite® sheet layer and a clear annealed float glass plate layer (12 inches by 12 inches (305 mm×305 mm) by 2.5 mm thick). The glass/interlayer/glass assembly is then laminated as described for Example 1.

### Example 9

An acoustic sheet prepared in Preparative Example PE 3 taped to a 6 mils (0.15 mm) thick biaxially-oriented poly(ethylene terephthalate) film is ink jet printed with an image with a NUR TEMPO Modular Flatbed Inkjet Press (NUR Microprinters, Monnachie, N.J.) equipped with a UV curing lamp on the print heads and utilizing a pigmented 4-color CMYK UV-curable inkset available from NUR Microprinters to provide an ink coverage of 250%. The tape and polyester film are removed to provide the image-bearing acoustic sheet.

A solution of Silquest® A-1100 silane, (0.10 weight % based on the total weight of the solution) (GE Silicones) (believed to be gamma-aminopropyltrimethoxysilane), acetic acid (0.01 weight % based on the total weight of the solution), isopropanol (66.59 weight % based on the total weight of the solution), and water (33.30 weight % based on the total weight of the solution) is prepared. A 12-inch by 12-inch piece of the image-bearing acoustic sheet is dipped into the silane solution (residence time of about 1 minute), removed and allowed to drain and dry under ambient conditions.

A glass laminate composed of a glass layer, the silane-primed image-bearing acoustic sheet interlayer, a surface flame-treated biaxially-oriented poly(ethylene terephthalate) (PET) film, a Butacite® poly(vinyl butyral) sheet (DuPont) and a glass layer is produced in the following manner. The primed, image-bearing acoustic sheet (12 inches by 12 inches (305 mm×305 mm)), the surface flame-treated biaxially-oriented PET film (12 inches by 12 inches (305 mm×305 mm) by 4 mils (0.10 mm) thick) and the Butacite® poly(vinyl butyral) sheet (12 inches by 12 inches (305 mm×305 mm) by 15 mils (0.38 mm) thick) are conditioned at 23% relative humidity (RH) at a temperature of 72° F. overnight. The samples are laid up with a clear annealed float glass plate layer (12 inches by 12 inches (305 mm×305 mm) by 2.5 mm thick), the primed image-bearing acoustic interlayer, the surface flame-treated PET film layer, the Butacite® poly(vinyl butyral) interlayer and a clear annealed float glass plate layer (12 inches by 12 inches (305 mm×305 mm) by 2.5 mm thick). The glass/interlayer/glass assembly is then laminated as described for Example 1.

### Example 10

An acoustic sheet prepared above in Preparative Example PE 3 taped to a 6 mils (0.15 mm) thick biaxially-oriented poly(ethylene terephthalate) film is ink jet printed on the with an image with a NUR TEMPO Modular Flatbed Inkjet Press (NUR Microprinters, Monnachie, N.J.) equipped with a UV curing lamp on the print heads and utilizing a pigmented 6-color CMYK+Iclm UV-curable inkset and a UV-curable white ink available from NUR Microprinters to provide an ink coverage of 550%. The tape and polyester film are removed to provide the image-bearing acoustic sheet.

The image-bearing surface is coated with a 0.5 weight % aqueous solution of poly(vinyl amine) with a #8 casting rod and is dried under ambient conditions.

A glass laminate composed of a glass layer, the primed image-bearing acoustic interlayer, and a surface flame-treated biaxially-oriented poly(ethylene terephthalate) (PET) film is produced in the following manner. The primed image-bearing acoustic sheet (12 inches by 12 inches (305 mm×305 mm)) and the surface flame-treated biaxially-oriented PET film (12 inches by 12 inches (305 mm×305 mm) by 4 mils (0.10 mm) thick) are conditioned at 23% relative humidity (RH) at a temperature of 72° F. overnight. The sample is laid up with a clear annealed float glass plate layer (12 inches by 12 inches (305 mm×305 mm) by 2.5 mm thick), the primed image-bearing acoustic interlayer, the surface flame-treated PET film layer, a thin Teflon® film layer, (12 inches by 12 inches (305 mm×305 mm)) (DuPont) and an annealed float glass layer (12 inches by 12 inches (305 mm×305 mm) by 2.5 mm thick). The glass/interlayer/PET film/Teflon® film/glass assembly is then laminated as described for Example 1. Removal of the glass cover sheet and the thin Teflon® film provides the glass/image-bearing acoustic interlayer/polyester film laminate of the invention.

### Example 11

Using the above mentioned ink set of Example 1, an acoustic sheet prepared in Preparative Example PE 1 taped to a 6 mils (0.15 mm) thick biaxially-oriented poly(ethylene terephthalate) film is ink jet printed with an image with an Epson 3000 printer to provide an ink coverage of 200%. The tape and polyester film are removed to provide the image-bearing acoustic sheet.

The image-bearing surface is coated with a 0.5 weight % aqueous solution of poly(vinyl amine) with a #8 casting rod and is dried under ambient conditions.

A glass laminate composed of a glass layer, the primed image-bearing acoustic sheet interlayer, a poly(allyl amine)-primed biaxially-oriented poly(ethylene terephthalate) (PET) film, an acoustic interlayer prepared in Preparative Example PE 1 and a glass layer is produced in the following manner. The primed image-bearing acoustic sheet (12 inches by 12 inches (305 mm×305 mm)), the poly(allyl amine)-primed biaxially-oriented PET film (12 inches by 12 inches (305 mm×305 mm) by 4 mils (0.10 mm) thick) and the acoustic sheet from Preparative Example PE 1 (12 inches by 12 inches (305 mm×305 mm) by 15 mils (0.38 mm) thick) are conditioned at 23% relative humidity (RH) at a temperature of 72° F. overnight. The samples are laid up with a clear annealed float glass plate layer (12 inches by 12 inches (305 mm×305 mm) by 2.5 mm thick), the primed image-bearing acoustic interlayer, the poly(allyl amine)-primed PET film layer, the acoustic interlayer from Preparative Example PE 1 and a clear annealed float glass plate layer (12 inches by 12 inches (305 mm×305 mm) by 2.5 mm thick). The glass/interlayer/glass assembly is then laminated as described in Example 1.

### Example 12

An acoustic sheet prepared in Preparative Example PE 2 taped to a 6 mils (0.15 mm) thick biaxially-oriented poly(ethylene terephthalate) film is ink jet printed with an image with a NUR TEMPO Modular Flatbed Inkjet Press (NUR Microprinters, Monnachie, N.J.) equipped with a UV curing lamp on the print heads and utilizing a pigmented 4-color CMYK UV-curable inkset available from NUR Microprinters to provide an ink coverage of 350%. The tape and polyester film are removed to provide the image-bearing acoustic sheet.

A solution of Silquest® A-1100 silane, (0.10 weight % based on the total weight of the solution) (GE Silicones) (believed to be gamma-aminopropyltrimethoxysilane), acetic acid (0.01 weight % based on the total weight of the solution), isopropanol (66.59 weight % based on the total weight of the solution), and water (33.30 weight % based on the total weight of the solution) is prepared. A 12-inch by 12-inch piece of the image-bearing acoustic sheet is dipped into the silane solution (residence time of about 1 minute), removed and allowed to drain and dry under ambient conditions.

A glass laminate composed of a glass layer, the silane-primed image-bearing acoustic sheet interlayer and a XIR®-70 HP Auto film (a product of the Southwall Company, Palo Alto, Calif.) is produced in the following manner. The silane-primed image-bearing acoustic sheet (12 inches by 12 inches (305 mm×305 mm)) and the XIR®-70 HP Auto films (12 inches by 12 inches (305 mm×305 mm), by 2 mils (0.05 mm) thick) are conditioned at 23% relative humidity (RH) at a temperature of 72° F. overnight. The sample is laid up with a clear annealed float glass plate layer (12 inches by 12 inches (305 mm×305 mm) by 2.5 mm thick), the silane-primed image-bearing acoustic interlayer, the XIR®-70 HP Auto film layer (with the metallized surface of the XIR®-70 HP Auto film in contact with the image-bearing surface of the primed image-bearing acoustic sheet layer), a thin Teflon® film layer (12 inches by 12 inches (305 mm×305 mm)) (DuPont) and an annealed float glass layer (12 inches by 12 inches (305 mm×305 mm) by 2.5 mm thick). The glass/interlayer/XIR®-70 HP Auto film/Teflon® film/glass assembly is then laminated as described for Example 1. Removal of the glass cover sheet and the thin Teflon® film provides the glass/image-bearing acoustic interlayer/XIR®-70 HP Auto film laminate of the invention.

### Example 13

An acoustic sheet prepared above in Preparative Example PE 2 taped to a 6 mils (0.15 mm) thick biaxially-oriented poly(ethylene terephthalate) film is ink jet printed on the with an image with a NUR TEMPO Modular Flatbed Inkjet Press (NUR Microprinters, Monnachie, N.J.) equipped with a UV curing lamp on the print heads and utilizing a pigmented 6-color CMYK+Iclm UV-curable inkset and a UV-curable white ink available from NUR Microprinters to provide an ink coverage of 450%. The tape and polyester film are removed to provide the image-bearing acoustic sheet.

A solution of Silquest®A-1100 silane, (0.10 weight % based on the total weight of the solution) (GE Silicones) (believed to be gamma-aminopropyltrimethoxysilane), acetic acid (0.01 weight % based on the total weight of the solution), isopropanol (66.59 weight % based on the total weight of the solution), and water (33.30 weight % based on the total weight of the solution) is prepared. A 12-inch by 12-inch piece of the image-bearing acoustic sheet is dipped into the silane solution (residence time of about 1 minute), removed and allowed to drain and dry under ambient conditions.

A glass laminate composed of a glass layer, the silane-primed image-bearing acoustic sheet interlayer, a XIR®-75 Auto Blue V-1 film, (Southwall Company), a Butacite® poly(vinyl butyral) interlayer, (DuPont) and a glass layer is produced in the following manner. The silane-primed image-bearing acoustic sheet (12 inches by 12 inches (305 mm×305 mm)), the XIR®-75 Auto Blue V-1 film (12 inches by 12 inches (305 mm×305 mm) by 1.8 mils (0.046 mm) thick) and the Butacite® poly(vinyl butyral) sheets (12 inches by 12 inches (305 mm×305 mm) by 15 mils (0.38 mm) thick) are conditioned at 23% relative humidity (RH) at a temperature of 72° F. overnight. The sample is laid up with a clear annealed float glass plate layer (12 inches by 12 inches (305 mm×305 mm) by 2.5 mm thick), the primed image-bearing acoustic interlayer, the XIR®-75 Auto Blue V-1 film layer, the Butacite® poly(vinyl butyral) interlayer and a clear annealed float glass plate layer (12 inches by 12 inches (305 mm×305 mm) by 2.5 mm thick). The glass/interlayer/glass assembly is then laminated as described for Example 1.

### Example 14

Using the above mentioned ink set of Example 1, an acoustic sheet prepared in Preparative Example PE 3 taped to a 6 mils (0.15 mm) thick biaxially-oriented poly(ethylene terephthalate) film is ink jet printed with an image with an Epson 3000 printer to provide an ink coverage of 150%. The tape and polyester film are removed to provide the image-bearing acoustic sheet.

A solution of Silquest® A-1100 silane, (0.10 weight % based on the total weight of the solution) (GE Silicones) (believed to be gamma-aminopropyltrimethoxysilane), acetic acid (0.01 weight % based on the total weight of the solution), isopropanol (66.59 weight % based on the total weight of the solution), and water (33.30 weight % based on the total weight of the solution) is prepared. A 12-inch by 12-inch piece of the image-bearing acoustic sheet is dipped into the silane solution (residence time of about 1 minute), removed and allowed to drain and dry under ambient conditions.

A glass laminate composed of a glass layer, the silane-primed image-bearing acoustic interlayer and a Soft Look® UV/IR 25 solar control film (a product of the Tomoegawa Paper Company, Ltd., of Tokyo, Japan) is produced in the following manner. The silane-primed image-bearing acoustic sheet (12 inches by 12 inches (305 mm×305 mm)) and the Soft Look® UV/IR 25 solar control film (12 inches by 12 inches (305 mm×305 mm)) are conditioned at 23% relative humidity (RH) at a temperature of 72° F. overnight. The sample is laid up with a clear annealed float glass plate layer (12 inches by 12 inches (305 mm×305 mm) by 2.5 mm thick), the silane-primed image-bearing acoustic interlayer, the Soft Look® UV/IR 25 solar control film layer (with the coated surface of the Soft Look® UV/IR 25 solar control film in contact with the image-bearing surface of the primed image-bearing acoustic interlayer), a thin Teflon® film layer, (12 inches by 12 inches (305 mm×305 mm)) (DuPont) and an annealed float glass layer (12 inches by 12 inches (305 mm×305 mm) by 2.5 mm thick). The glass/interlayer/Soft Look® UV/IR 25 solar control film/Teflon® film/glass assembly is then laminated as described for Example 1. Removal of the glass cover sheet and the thin Teflon® film provides the glass/image-bearing acoustic interlayer/Soft Look® UV/IR 25 solar control film laminate of the invention.

### Example 15

An acoustic sheet prepared in Preparative Example PE 2 taped to a 6 mils (0.15 mm) thick biaxially-oriented poly(ethylene terephthalate) film is ink jet printed with an image with a NUR TEMPO Modular Flatbed Inkjet Press (NUR Microprinters, Monnachie, N.J.) equipped with a UV curing lamp on the print heads and utilizing a pigmented 4-color CMYK UV-curable inkset available from NUR Microprinters to provide an ink coverage of 250%. The tape and polyester film are removed to provide the image-bearing acoustic sheet.

A solution of Silquest® A-1100 silane, (0.10 weight % based on the total weight of the solution) (GE Silicones) (believed to be gamma-aminopropyltrimethoxysilane), acetic acid (0.01 weight % based on the total weight of the solution), isopropanol (66.59 weight % based on the total weight of the solution), and water (33.30 weight % based on the total weight of the solution) is prepared. A 12-inch by 12-inch piece of the image-bearing acoustic sheet is dipped into the silane solution (residence time of about 1 minute), removed and allowed to drain and dry under ambient conditions.

A glass laminate composed of a glass layer, the silane-primed image-bearing acoustic sheet interlayer, a XIR®-75 Green film (Southwall Company), an acoustic poly(vinyl butyral) sheet from Preparative Example PE 1 and a glass layer is produced in the following manner. The silane-primed image-bearing acoustic sheet (12 inches by 12 inches (305 mm×305 mm)), the XIR®-75 Green film (12 inches by 12 inches (305 mm×305 mm) by 1.8 mils (0.046 mm) thick) and the sheet from Preparative Example PE 1 (12 inches by 12 inches (305 mm×305 mm) by 15 mils (0.38 mm) thick) are conditioned at 23% relative humidity (RH) at a temperature of 72° F. overnight. The sample is laid up with a clear annealed float glass plate layer (12 inches by 12 inches (305 mm×305 mm) by 2.5 mm thick), the silane-primed image-bearing acoustic interlayer, the XIR®-75 Green film layer, the interlayer from Preparative Example PE 1 and a clear annealed float glass plate layer (12 inches by 12 inches (305 mm×305 mm) by 2.5 mm thick). The glass/interlayer/glass assembly is then laminated as described for Example 1.

### Example 16

An acoustic sheet prepared above in Preparative Example PE 1 taped to a 6 mils (0.15 mm) thick biaxially-oriented poly(ethylene terephthalate) film is ink jet printed on the with an image with a NUR TEMPO Modular Flatbed Inkjet Press (NUR Microprinters, Monnachie, N.J.) equipped with a UV curing lamp on the print heads and utilizing a pigmented 6-color CMYK+Iclm UV-curable inkset and a UV-curable white ink available from NUR Microprinters to provide an ink coverage of 500%. The tape and polyester film are removed to provide the image-bearing acoustic sheet.

A solution of Silquest® A-1100 silane, (0.10 weight % based on the total weight of the solution) (GE Silicones) (believed to be gamma-aminopropyltrimethoxysilane), acetic acid (0.01 weight % based on the total weight of the solution), isopropanol (66.59 weight % based on the total weight of the solution), and water (33.30 weight % based on the total weight of the solution) is prepared. A 12-inch by 12-inch piece of the image-bearing acoustic sheet is dipped into the silane solution (residence time of about 1 minute), removed and allowed to drain and dry under ambient conditions.

A glass laminate composed of a glass layer, the silane-primed image-bearing acoustic sheet interlayer, an acoustic interlayer from Preparative Example PE 1 and a RAYBARRIER® TFK-2583 solar control film (a product of the Sumitomo Osaka Cement Company, Tokyo, Japan) is produced in the following manner. The silane-primed image-bearing acoustic sheet (12 inches by 12 inches (305 mm×305 mm)), the acoustic sheet from Preparative Example PE 1 (12 inches by 12 inches (305 mm×305 mm) by 15 mils thick (0.38 mm)) and the RAYBARRIER® TFK-2583 solar control film (12 inches by 12 inches (305 mm×305 mm)) are conditioned at 23% relative humidity (RH) at a temperature of 72° F. overnight. The sample is laid up with a clear annealed float glass plate layer (12 inches by 12 inches (305 mm×305 mm) by 2.5 mm thick), the silane-primed image-bearing acoustic interlayer, the acoustic interlayer from Preparative Example PE 1, the RAYBARRIER® TFK-2583 solar control film layer (the coated surface of the RAYBARRIER® TFK-2583 solar control film in contact with a surface of the acoustic sheet), a thin Teflon® film layer, (12 inches by 12 inches (305 mm×305 mm)) (DuPont) and an annealed float glass layer (12 inches by 12 inches (305 mm×305 mm) by 2.5 mm thick). The glass/interlayer/RAYBARRIER® TFK-2583 film/Teflon® film/glass assembly is then laminated as described for Example 1. Removal of the glass cover sheet and the thin Teflon® film provides the glass/decorated acoustic sheet/acoustic sheet/RAYBARRIER® TFK-2583 film laminate of the present invention.

### Example 17

Using the above mentioned ink set of Example 1, an acoustic sheet prepared in Preparative Example PE 1 taped to a 6 mils (0.15 mm) thick biaxially-oriented poly(ethylene terephthalate) film is ink jet printed with an image with an Epson 3000 printer to provide an ink coverage of 250%. The tape and polyester film are removed to provide the image-bearing acoustic sheet.

A solution of Silquest® A-1100 silane, (0.10 weight % based on the total weight of the solution) (GE Silicones) (believed to be gamma-aminopropyltrimethoxysilane), acetic acid (0.01 weight % based on the total weight of the solution), isopropanol (66.59 weight % based on the total weight of the solution), and water (33.30 weight % based on the total weight of the solution) is prepared. A 12-inch by 12-inch piece of the image-bearing acoustic sheet is dipped into the silane solution (residence time of about 1 minute), removed and allowed to drain and dry under ambient conditions.

A glass laminate composed of a glass layer, the silane-primed image-bearing acoustic interlayer, an acoustic interlayer from Preparative Example PE 1, a XIR®-70 HP film (Southwall Company), a second acoustic sheet from Preparative Example PE 1 and a glass layer is produced in the following manner. The silane-primed image-bearing acoustic sheet (12 inches by 12 inches (305 mm×305 mm)), the XIR®-70 HP film (12 inches by 12 inches (305 mm×305 mm) by 1 mil (0.026 mm) thick) and the acoustic sheets from Preparative Example PE 1 (12 inches by 12 inches (305 mm×305 mm) by 15 mils (0.38 mm) thick) are conditioned at 23% relative humidity (RH) at a temperature of 72° F. overnight. The sample is laid up with a clear annealed float glass plate layer (12 inches by 12 inches (305 mm×305 mm) by 2.5 mm thick), the silane-primed image-bearing acoustic interlayer, the acoustic interlayer (with the image-bearing surface of the image-bearing acoustic interlayer in contact with a surface of the acoustic interlayer), the XIR®-70 HP film layer, the second acoustic interlayer and a clear annealed float glass plate layer (12 inches by 12 inches (305 mm×305 mm) by 2.5 mm thick). The glass/interlayer/glass assembly is then laminated as described in Example 1.

### Example 18

An acoustic sheet prepared in Preparative Example PE 2 taped to a 6 mils (0.15 mm) thick biaxially-oriented poly(ethylene terephthalate) film is ink jet printed with an image with a NUR TEMPO Modular Flatbed Inkjet Press (NUR Microprinters, Monnachie, N.J.) equipped with a UV curing lamp on the print heads and utilizing a pigmented 4-color CMYK UV-curable inkset available from NUR Microprinters to provide an ink coverage of 350%. The tape and polyester film are removed to provide the image-bearing acoustic sheet.

A solution of Silquest® A-1100 silane, (0.10 weight % based on the total weight of the solution) (GE Silicones) (believed to be gamma-aminopropyltrimethoxysilane), acetic acid (0.01 weight % based on the total weight of the solution), isopropanol (66.59 weight % based on the total weight of the solution), and water (33.30 weight % based on the total weight of the solution) is prepared. A 12-inch by 12-inch piece of the image-bearing acoustic sheet is dipped into the silane solution (residence time of about 1 minute), removed and allowed to drain and dry under ambient conditions.

A glass laminate composed of a glass layer, the silane-primed image-bearing acoustic interlayer, a XIR®-75 Auto Blue V-1 film (Southwall Company), a SentryGlas® Plus SGP5000 interlayer (DuPont) and a glass layer is produced in the following manner. The silane-primed image-bearing acoustic sheet (12 inches by 12 inches (305 mm×305 mm)), the XIR®-75 Auto Blue V-1 film (12 inches by 12 inches (305 mm×305 mm) by 1.8 mils (0.046 mm) thick) and the SentryGlas® Plus SGP5000 sheets (12 inches by 12 inches (305 mm×305 mm) by 60 mils (1.52 mm) thick) are conditioned at 23% relative humidity (RH) at a temperature of 72° F. overnight. The sample is laid up with a clear annealed float glass plate layer (12 inches by 12 inches (305 mm×305 mm) by 2.5 mm thick), the silane-primed image-bearing acoustic interlayer, the XIR®-75 Auto Blue V-1 film layer, the SentryGlas® Plus SGP5000 interlayer and a clear annealed float glass plate layer (12 inches by 12 inches (305 mm×305 mm) by 2.5 mm thick). The glass/interlayer/glass assembly is then laminated as described for Example 1.

### Example 19

An acoustic sheet prepared above in Preparative Example PE 3 taped to a 6 mils (0.15 mm) thick biaxially-oriented poly(ethylene terephthalate) film is ink jet printed on the with an image with a NUR TEMPO Modular Flatbed Inkjet Press (NUR Microprinters, Monnachie, N.J.) equipped with a UV curing lamp on the print heads and utilizing a pigmented 6-color CMYK+Iclm UV-curable inkset and a UV-curable white ink available from NUR Microprinters to provide an ink coverage of 550%. The tape and polyester film are removed to provide the image-bearing acoustic sheet.

A solution of Silquest®A-1100 silane, (0.10 weight % based on the total weight of the solution) (GE Silicones) (believed to be gamma-aminopropyltrimethoxysilane), acetic acid (0.01 weight % based on the total weight of the solution), isopropanol (66.59 weight % based on the total weight of the solution), and water (33.30 weight % based on the total weight of the solution) is prepared. A 12-inch by 12-inch piece of the image-bearing acoustic sheet is dipped into the silane solution (residence time of about 1 minute), removed and allowed to drain and dry under ambient conditions.

A glass laminate composed of a glass layer, the silane-primed image-bearing acoustic sheet interlayer, a XIR®-70 HP film (Southwall Company), an Evasafe® ethylene vinyl acetate interlayer (a product of the Bridgestone Americas Holding, Inc., Chicago, Ill.) and a glass layer is produced in the following manner. The silane-primed image-bearing acoustic sheet (12 inches by 12 inches (305 mm×305 mm)), the XIR®-70 HP film (12 inches by 12 inches (305 mm×305 mm) by 1 mil (0.026 mm) thick) and the Evasafe® ethylene vinyl acetate sheet (12 inches by 12 inches (305 mm×305 mm) by 15 mils (0.38 mm) thick) are conditioned at 23% relative humidity (RH) at a temperature of 72° F. overnight. The sample is laid up with a clear annealed float glass plate layer (12 inches by 12 inches (305 mm×305 mm) by 2.5 mm thick), the silane-primed image-bearing acoustic interlayer, the XIR®-70 HP film layer, the Evasafe® interlayer and a clear annealed float glass plate layer (12 inches by 12 inches (305 mm×305 mm) by 2.5 mm thick). The glass/interlayer/glass assembly is then laminated as described for Example 1.

What is claimed:

1. An image-bearing article comprising an interlayer bearing an image wherein the interlayer is an acoustic poly(vinyl acetal) interlayer having a Tg of 23° C. or less.

2. The image-bearing article of claim 1 wherein the acoustic poly(vinyl acetal) interlayer is an interlayer of poly(vinyl acetal) with acetal groups derived from reacting poly(vinyl alcohol) with aldehydes containing 6 to 10 carbon atoms.

3. The image-bearing article of claim 2 wherein the aldehydes are selected from the group consisting of n-hexylaldehyde, 2-ethylbutyraldehyde, n-heptylaldehyde, n-octylaldehyde, n-nonylaldehyde, n-decylaldehyde, benzaldehyde, and cinnamaldehyde.

4. The image-bearing article of claim 3 wherein the poly(vinyl acetal) is produced by acetalizing poly(vinyl alcohol) with aldehydes containing 6 to 10 carbon atoms to a degree of acetalization of at least 50 mole % and has an average polymerization degree of from about 1000 to about 3000.

5. The image-bearing article of claim 2 wherein the aldehydes contain 6 to 8 carbon atoms.

6. The image-bearing article of claim 2 wherein the poly(vinyl acetal) contains plasticizer in an amount of about 30 to about 60 parts per hundred (pph) based on 100 parts by weight of poly(vinyl acetal).

7. The image-bearing article of claim 2 wherein the poly(vinyl alcohol) contains residual acetyl groups in the range of about 2 to about 0.01 mole % of the total of the main chain vinyl groups.

8. The image-bearing article of claim 1 wherein the acoustic poly(vinyl acetal) interlayer is an interlayer of poly(vinyl acetal) with acetyl groups in the range of about 8 to about 30 mole % of the total of the main chain vinyl groups.

9. The image-bearing article of claim 8 wherein the acoustic poly(vinyl acetal) interlayer is an interlayer of poly(vinyl acetal) with acetal groups derived from reacting poly(vinyl alcohol) with aldehydes containing 4 to 6 carbon atoms.

10. The image-bearing article of claim 9 wherein the aldehydes are selected from the group consisting of n-butyl aldehyde, isobutyl aldehyde, valeraldehyde, n-hexyl aldehyde and 2-ethylbutyl aldehyde and mixtures thereof.

11. The image-bearing article of claim 9 wherein the poly(vinyl acetal) has an average polymerization degree of from about 500 to about 3000.

12. The image-bearing article of claim 9 wherein the poly(vinyl acetal) contains plasticizer in an amount of about 30 to about 70 parts per hundred (pph) based on 100 parts by weight of poly(vinyl acetal).

13. The image-bearing article of claim 8 wherein the poly(vinyl acetal) is poly(vinyl butyral).

14. The image-bearing article of claim 1 wherein the acoustic poly(vinyl acetal) interlayer is an interlayer of poly(vinyl acetal) containing plasticizer in an amount of about 40 to about 60 parts per hundred (pph) based on 100 parts by weight of poly(vinyl acetal).

15. The image-bearing article of claim 7 wherein the acoustic poly(vinyl acetal) interlayer is an interlayer of poly(vinyl acetal) containing plasticizer in an amount of about 40 to about 60 parts per hundred (pph) based on 100 parts by weight of poly(vinyl acetal).

16. The image-bearing article of claim 14 wherein the poly(vinyl acetal) is poly(vinyl butyral).

17. The image-bearing article of claim 1 comprising on the image-bearing surface of the interlayer a coating of an adhesion promoter.

18. The image-bearing article of claim 1 further comprising a rigid layer adhered to the interlayer, wherein the rigid layer is selected from the group consisting of glass, poly(carbonate) and poly(methacrylate) sheets.

19. The image-bearing article of claim 18 wherein the interlayer is adhered on the image-bearing side to the rigid layer by an adhesion promoter.

20. The image-bearing article of claim 19 wherein the adhesion promoter is selected from the group consisting of silane and poly(alkyl amine) adhesion promoters, and mixtures thereof.

21. A process of forming an image on a poly(vinyl acetal) s interlayer sheet, comprising (a) providing a poly(vinyl acetal) interlayer sheet, wherein the interlayer is an acoustic poly(vinyl acetal) interlayer having a Tg of 23° C. or less, and (b) ink-jet printing an image onto the poly(vinyl acetal) interlayer sheet.

22. The process of claim 21 further comprising laminating the poly(vinyl acetal) interlayer sheet to a rigid layer, wherein the rigid layer is selected from the group consisting of glass, poly(carbonate) and poly(methacrylate) sheets.
